(19) United States
(12) Patent Application Publication
(10) Pub. No.: US 2022/0402809 A1
(43) Pub. Date: Dec. 22, 2022

(54) PRECURSOR GLASSES AND TRANSPARENT GLASS-CERAMIC ARTICLES FORMED THEREFROM AND HAVING IMPROVED MECHANICAL DURABILITY

(71) Applicant: CORNING INCORPORATED, Corning, NY (US)

(72) Inventors: Erin Coon, Lewisburg, PA (US); Qiang Fu, Painted Post, NY (US); Charlene Marie Smith, Corning, NY (US); Alana Marie Whittier, Painted Post, NY (US)

(21) Appl. No.: 17/839,776

(22) Filed: Jun. 14, 2022

Related U.S. Application Data
(60) Provisional application No. 63/212,139, filed on Jun. 18, 2021.

(51) Int. Cl. C03C 10/00; C03B 32/02; C03C 21/00

(52) U.S. Cl. CPC C03C 10/00; C03B 32/02; C03C 21/002; C03C 2204/00

(57) ABSTRACT

A glass-ceramic article includes a crystalline phase; a residual glass phase; greater than or equal to 52 mol % and less than or equal to 70 mol % SiO₂, greater than or equal to 14 mol % and less than or equal to 35 mol % Li₂O, greater than or equal to 0.1 mol % and less than or equal to 15 mol % CaO, greater than or equal to 0.5 mol % and less than or equal to 10 mol % ZrO₂; and greater than or equal to 0.5 mol % and less than or equal to 5 mol % P₂O₅.

This application claims the benefit of priority of U.S. Provisional Application Ser. No. 63/212,139 filed on Jun. 18, 2021, the content of which is relied upon and incorporated herein by reference in its entirety.

### FIELD

The present specification relates to precursor glass compositions and glass-ceramic articles and, in particular, to precursor glass compositions and ion exchangeable glass-ceramic articles formed therefrom.

### TECHNICAL BACKGROUND

Glass articles, such as cover glasses, glass backplanes, housings, and the like, are employed in both consumer and commercial electronic devices, such as smart phones, tablets, portable media players, personal computers, and cameras. The mobile nature of these portable devices makes the devices and the glass articles included therein particularly vulnerable to accidental drops on hard surfaces, such as the ground. Moreover, glass articles, such as cover glasses, may include “touch” functionality which necessitates that the glass article be contacted by various objects including a user's fingers and/or stylus devices. Accordingly, the glass articles must be sufficiently robust to endure accidental dropping and regular contact without damage, such as scratching. Indeed, scratches introduced into the surface of the glass article may reduce the strength of the glass article as the scratches may serve as initiation points for cracks leading to catastrophic failure of the glass.

Moreover, the optical characteristics of the glass article, such as the transmittance of the glass article, may be an important consideration when the glass article is incorporated as a cover glass in a portable electronic device.

Accordingly, a need exists for alternative materials which have improved mechanical properties relative to glass while also having optical characteristics similar to glass.

### SUMMARY

According to a first aspect A1, a glass-ceramic article may comprise: a crystalline phase; a residual glass phase; greater than or equal to 52 mol % and less than or equal to 70 mol % SiO₂; greater than or equal to 14 mol % and less than or equal to 35 mol % Li₂O; greater than or equal to 0.1 mol % and less than or equal to 15 mol % CaO; greater than or equal to 0.5 mol % and less than or equal to 10 mol % ZrO₂; and greater than or equal to 0.5 mol % and less than or equal to 5 mol % P₂O₅.

A second aspect A2 includes the glass-ceramic article according to the first aspect A1, wherein the crystalline phase comprises lithium disilicate, wherein lithium disilicate is present in a greater amount, based on a total weight of the crystalline phase, than any other crystalline phase.

A third aspect A3 includes the glass-ceramic article according to the second aspect A2, wherein grains of the lithium disilicate comprise a grain size greater than or equal to 10 nm and less than or equal to 200 nm.

A fourth aspect A4 includes the glass-ceramic article according to any one of the first through third aspects A1-A3, wherein the glass-ceramic article comprises greater than or equal to 18 mol % and less than or equal to 32 mol % Li₂O.

A fifth aspect A5 includes the glass-ceramic article according to any one of the first trough fourth aspects A1-A4, wherein the glass-ceramic article comprises greater than or equal to 0.5 mol % and less than or equal to 7 mol % ZrO₂.

A sixth aspect A6 includes the glass-ceramic article according to any one of the first through fifth aspects A1-A5, wherein the glass-ceramic article comprises greater than or equal to 1 mol % and less than or equal to 4.5 mol % P₂O₅.

A seventh aspect A7 includes the glass-ceramic article according to any one of the first through sixth aspects A1-A6, wherein the glass-ceramic comprises greater than or equal to 0 mol % and less than or equal to 7 mol % Al₂O₃.

An eighth aspect A8 includes the glass-ceramic article according to the seventh aspect A7, wherein the glass-ceramic article comprises greater than or equal to 0.5 mol % and less than or equal to 5 mol % Al₂O₃.

A ninth aspect A9 includes the article according to any one of the first through eighth aspects A1-A8, wherein a molar ratio of Al₂O₃ to SiO₂ is greater than or equal to 0 and less than or equal to 0.2.

A tenth aspect A10 includes the glass-ceramic article according to any one of the first through ninth aspects A1-A9, wherein R₂O is greater than or equal to 14 mol % and less than or equal to 40 mol %, wherein R₂O is the sum of Li₂O, Na₂O, and K₂O.

An eleventh aspect A11 includes the glass-ceramic article according to any one of the first through tenth aspects A1-A10, wherein a molar ratio of Li₂O to SiO₂ is greater than or equal to 0.2 and less than or equal to 0.7.

A twelfth aspect A12 includes the glass-ceramic article according to an one of the first through eleventh aspects A1-A11, wherein R′O is greater than or equal to 0.1 mol % and less than or equal to 15 mol %, wherein R′O is the sum of CaO, MgO, ZnO, SrO, and BaO.

A thirteenth aspect A13 includes the glass-ceramic article according to any one of the first through twelfth aspects A1-A12, wherein a molar ratio of R′O to SiO₂ is greater than or equal to 0 and less than or equal to 0.3, wherein R′O is the sum of CaO, MgO, ZnO, SrO, and BaO.

A fourteenth aspect A14 includes the glass-ceramic article according to any one of the first through thirteenth aspect A1-A13, wherein the glass-ceramic article comprises greater than or equal to 0 mol % and less than or equal to 6 mol % La₂O₃.

A fifteenth aspect A15 includes the glass-ceramic article according to any one of the first through fourteenth aspects A1-A14, wherein the glass-ceramic article comprises greater than or equal to 0 mol % and less than or equal to 5 mol % F.

A sixteenth aspect A16 includes the glass-ceramic article according to any one of the first through fifteenth aspects A1-A15, wherein the glass-ceramic article comprises: greater than 0 mol % and less than or equal to 5 mol % Na₂O; and greater than or equal to 0 mol % and less than or equal to 5 mol % K₂O.

A seventeenth aspect A17 includes the glass-ceramic article according to any one of the first through sixteenth aspects A1-A16, wherein the glass-ceramic article comprises: greater than or equal to 0 mol % and less than or equal to 6 mol % MgO; greater than or equal to 0 mol % and less than or equal to 5 mol % ZnO; greater than or equal to 0 mol % and less than or equal to 6 mol % SrO; and greater than or equal to 0 mol % and less than or equal to 6 mol % BaO.

An eighteenth aspect A18 includes the glass-ceramic article according to any one of the first through seventeenth aspects A1-A17, wherein the crystalline phase of the glass-ceramic article comprises lithium metasilicate, lithium phosphate, petalite, β-quartz, apatite, or combinations thereof.

A nineteenth aspect A19 includes the glass-ceramic article according to any one of the first through eighteenth aspect A1-A18, wherein an average transmittance of the glass-ceramic article is greater than or equal to 50% and less than or equal to 95% over the wavelength range of 400 nm to 800 nm as measured at an article thickness of 0.8 mm.

A twentieth aspect A20 includes the glass-ceramic article according to any one of the first through nineteenth aspects A1-A19, wherein a K_{lc} fracture toughness of the glass-ceramic article as measured by a double torsion method is greater than or equal to 1.0 MPa·m^{1/2}.

A twentieth aspect A21 includes the glass-ceramic article according to any one of the first through twentieth aspects A1-A20, wherein an elastic modulus of the glass-ceramic article is greater than or equal to 100 GPa.

According to a twenty-second aspect A22, a glass composition may comprise: greater than or equal to 52 mol % and less than or equal to 70 mol % SiO₂; greater than or equal to 14 mol % and less than or equal to 35 mol % Li₂O; greater than or equal to 0.1 mol % and less than or equal to 15 mol % CaO; greater than or equal to 0.5 mol % and less than or equal to 10 mol % ZrO₂; and greater than or equal to 0.5 mol % and less than or equal to 5 mol % P₂O₅.

A twenty-third aspect A23 includes the glass composition according to the twenty-second aspect A22, wherein the glass composition comprises greater than or equal to 18 mol % and less than or equal to 32 mol % Li₂O.

A twenty-fourth aspect A24 includes the glass composition according to the twenty-second A22 or twenty-third aspect A23, wherein the glass composition comprises greater than or equal to 0.5 mol % and less than or equal to 7 mol % ZrO₂.

A twenty-fifth aspect A25 includes the glass composition according to any one of the twenty-second through twenty-fourth aspects A22-A24, wherein the glass composition comprises greater than or equal to 1 mol % and less than or equal to 4.5 mol % P₂O₅.

A twenty-sixth aspect A26 includes the glass composition according to any one of the twenty-second through twenty-fifth aspects A22-A25, wherein the glass composition comprises greater than or equal to 0 mol % and less than or equal to 7 mol % Al₂O₃.

A twenty-seventh aspect A27 includes the glass composition according to the twenty-sixth aspect A26, wherein the glass composition comprises greater than or equal to 0.5 mol % and less than or equal to 4 mol % Al₂O₃.

A twenty-eighth aspect A28 includes the glass composition according to any one of the twenty-second through twenty-seventh aspects A22-A27, wherein a molar ratio of Al₂O₃ to SiO₂ is greater than or equal to 0 and less than or equal to 0.2.

A twenty-ninth aspect A29 includes the glass composition according to any one of the twenty-second through twenty-eighth aspects A22-A28, wherein R₂O is greater than or equal to 14 mol % and less than or equal to 40 mol %, wherein R₂O is the sum of Li₂O, Na₂O, and K₂O.

A thirtieth aspect A30 includes the glass composition according to any one of the twenty-second through twenty-ninth aspects A22-A29, wherein a molar ratio of Li₂O to SiO₂ is greater than or equal to 0.2 and less than or equal to 0.7.

A thirty-first aspect A31 includes the glass composition according to any one of the twenty-second through thirtieth aspects A22-A30, wherein R′O is greater than or equal to 0.1 mol % and less than or equal to 15 mol %, wherein R′O is the sum of CaO, MgO, ZnO, SrO, and BaO.

A thirty-second aspect A32 includes the glass composition according to any one of the twenty-second through thirty-first aspects A22-A31, wherein a molar ratio of R′O to SiO₂ is greater than or equal to 0 and less than or equal to 0.3, wherein R′O is the sum of CaO, MgO, ZnO, SrO, and BaO.

A thirty-third aspect A33 includes the glass composition according to any one of the twenty-second through thirty-second aspects A22-A32, wherein the glass composition comprises greater than or equal to 0 mol % and less than or equal to 6 mol % La₂O₃.

A thirty-fourth aspect A34 includes the glass composition according to any one of the twenty-second aspect through thirty-third aspects A22-A33, wherein the glass composition comprises greater than or equal to 0 mol % and less than or equal to 5 mol % F.

A thirty-fifth aspect A35 includes the glass composition according to any one of the twenty-second through thirty-fourth aspect A22-A34, wherein the glass composition comprises: greater than 0 mol % and less than or equal to 5 mol % Na₂O; and greater than or equal to 0 mol % and less than or equal to 5 mol % K₂O.

A thirty-sixth aspect A36 includes the glass composition according to any one of the twenty-second through thirty-fifth aspects A22-A35, wherein the glass composition comprises: greater than or equal to 0 mol % and less than or equal to 6 mol % MgO; greater than or equal to 0 mol % and less than or equal to 5 mol % ZnO; greater than or equal to 0 mol % and less than or equal to 6 mol % SrO; and greater than or equal to 0 mol % and less than or equal to 6 mol % BaO.

According to a thirty-seventh aspect A37, a method of forming a glass-ceramic article may comprise: heating a precursor glass article in an oven at a rate greater than or equal to 1° C./min and less than or equal to 10° C./min to a nucleation temperature, wherein the precursor glass article comprises a precursor glass composition comprising: greater than or equal to 52 mol % and less than or equal to 70 mol % SiO₂; greater than or equal to 14 mol % and less than or equal to 35 mol % Li₂O; greater than or equal to 0.1 mol % and less than or equal to 15 mol % CaO; greater than or equal to 0.5 mol % and less than or equal to 10 mol % ZrO₂; and greater than or equal to 0.5 mol % and less than or equal to 5 mol % P₂O₅; maintaining the precursor glass article at the nucleation temperature in the oven for a time greater than or equal to 0.1 hour and less than or equal to 8 hours to produce a nucleated crystallizable glass article; heating the nucleated crystallizable glass article in the oven at a rate greater than or equal to 1° C./min and less than or equal to 10° C./min to a crystallization temperature; maintaining the nucleated crystallizable glass article at the crystallization temperature in the oven for a time greater than or equal to 0.25 hour and less than or equal to 4 hours to produce the glass-ceramic article, wherein the glass-ceramic article comprises a crystalline phase and a residual glass phase; and cooling the glass-ceramic article to room temperature.

A thirty-eighth aspect A38 includes the method according to the thirty-seventh aspect A37, wherein the crystalline phase comprises lithium disilicate, wherein lithium disilicate is present in a greater amount, based on a total weight of the crystalline phase, than any other crystalline phase.

A thirty-ninth aspect A39 includes the method according to the thirty-seventh aspect A37 or thirty-eighth aspect A38, further comprising strengthening the glass-ceramic article in an ion exchange bath at a temperature greater than or equal to 350° C. to less than or equal to 500° C. for a time period greater than or equal to 2 hours to less than or equal to 12 hours to form an ion exchanged glass-ceramic article.

A fortieth aspect A40 includes thr method according to the thirty-ninth aspect A39, wherein the ion exchange bath comprises KNO₃.

A forty-first aspect A41 includes thr method according to the fortieth aspect A40, wherein the ion exchange bath comprises NaNO₃.

A forty-second aspect A42 includes the method according to any one of the thirty-seventh through forty-first aspects A37-A41, wherein an average transmittance of the glass-ceramic article is greater than or equal to 50% and less than or equal to 95% over the wavelength range of 400 nm to 800 nm as measured at an article thickness of 0.8 mm.

A forty-third aspect A43 includes the method according to any one of the thirty-seventh through forty-second aspects A37-A42, wherein a K_{lc} fracture toughness of the glass-ceramic article as measured by a double torsion method is greater than or equal to 1.0 MPa·m^{1/2}.

A forty-fourth aspect A44 includes the method according to any one of the thirty-seventh through forty-third aspect A37-A43, wherein an elastic modulus of the glass-ceramic article is greater than or equal to 100 GPa.

A forty-fifth aspect A45 includes a method according to any one of the thirty-seventh through forty-fourth aspects A37-A44, wherein a stored strain energy of the glass-ceramic article is greater than or equal to 15 J/m².

According to a forty-sixth aspect A46, a consumer electronic device may comprise: a housing having a front surface, a back surface, and side surfaces; electrical components provided at least partially within the housing, the electrical components including at least a controller, a memory, and a display, the display being provided at or adjacent the front surface of the housing; and the glass-ceramic article of any of the first through the twenty-first aspects A1-A21 at least one of disposed over the display and forming a portion of the housing.

Additional features and advantages of the precursor glass compositions and the resultant glass-ceramic articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a representation of a non-frangible sample after a frangibility test;

FIG. 2 is a representation of a frangible sample after a frangibility test;

FIG. 3 is a plan view of an electronic device incorporating any of the glass-ceramic articles according to one or more embodiments described herein;

FIG. 4 is a perspective view of the electronic device of FIG. 3;

FIG. 5 is a plot of total transmittance percentage and diffuse transmittance percentage (y-axis) verses wavelength (x-axis) of a glass-ceramic article made from a precursor glass composition according to one or more embodiments described herein;

FIG. 6 is a plot of total transmittance percentage (y-axis) verses wavelength (x-axis) of a glass-ceramic article made from a precursor glass composition according to one or more embodiments described herein;

FIG. 7 is a plot of scatter ratio percentage (y-axis) verses wavelength (x-axis) of a glass-ceramic article made from a precursor glass composition according to one or more embodiments described herein;

FIG. 8 is a plot of an XRD spectrum (x-axis: Two-Theta; y-axis: Intensity) of a glass-ceramic article made from a precursor glass composition according to one or more embodiments described herein;

FIG. 9 is a plot of an XRD spectrum (x-axis: Two-Theta; y-axis: Intensity) of a glass-ceramic article made from a precursor glass composition according to one or more embodiments described herein;

FIG. 10 is a scanning electron microscopy (SEM) image of a glass-ceramic article made from a precursor glass composition according to one or more embodiments described herein;

FIG. 11 is a further magnified SEM image of FIG. 10;

FIG. 12 is an SEM image of a glass-ceramic article made from a precursor glass composition according to one or more embodiments described herein;

FIG. 13 is a further magnified SEM image of FIG. 12;

FIG. 14 is an SEM image of a glass-ceramic article made from a precursor glass composition according to one or more embodiments described herein;

FIG. 15 is a further magnified SEM image of FIG. 14;

FIG. 16 is a plot of grain size (y-axis) verses nucleation hold time (x-axis) of glass-ceramic articles made from a precursor glass composition according to one or more embodiments described herein

FIG. 17 is a plot of crystallinity (y-axis) verses nucleation hold time (x-axis) of glass-ceramic articles made from a precursor glass composition according to one or more embodiments described herein;

FIG. 18 is a plot of fracture toughness (y-axis) verses crystallinity (x-axis) of glass-ceramic articles made from a precursor glass composition according to one or more embodiments described herein;

FIG. 19 is an SEM image of a glass-ceramic article made from a precursor glass composition according to one or more embodiments described herein;

FIG. 20 is an SEM image of a glass-ceramic article made from a precursor glass composition according to one or more embodiments described herein;

FIG. 21 is an SEM image of a glass-ceramic article made from a precursor glass composition according to one or more embodiments described herein;

FIG. 22 is a plot of transmittance percentage (y-axis) verses wavelength (x-axis) of glass-ceramic articles made from precursor glass compositions according to one or more embodiments described herein;

FIG. 23 is a plot of central tension (y-axis) verses ion exchange time (x-axis) of glass-ceramic articles made from precursor glass compositions according to one or more embodiments described herein;

FIG. 24 is a plot of sodium concentration (y-axis) versus depth (x-axis) of example glass-ceramic articles made from a precursor glass composition according to one or more embodiments described herein;

FIG. 25 is a plot of central tension (y-axis) verses ion exchange time (x-axis) of glass-ceramic articles made from precursor glass compositions according to one or more embodiments described herein;

FIG. 26 is a plot of weight gain (y-axis) verses square root of ion exchange time (x-axis) of glass-ceramic articles made from precursor glass compositions according to one or more embodiments described herein;

FIG. 27 is a photograph of a glass-ceramic article made from a precursor glass composition and subjected to a frangibility test according to one or more embodiments described herein;

FIG. 28 is a photograph of a glass-ceramic article made from a precursor glass composition and subjected to a frangibility test according to one or more embodiments described herein;

FIG. 29 is a photograph of a glass-ceramic article made from a precursor glass composition and subjected to a frangibility test according to one or more embodiments described herein;

FIG. 30 is an optical image of a glass-ceramic article with an intense light shone at the edge and made from a precursor glass composition and subjected to an aging test according to one or more embodiments described herein;

FIG. 31 is an optical image of a glass-ceramic article with an intense light shone at the edge and made from a precursor glass composition and subjected to an aging test according to one or more embodiments described herein;

FIG. 32 is an optical image of a glass-ceramic article with an intense light shone at the edge and made from a precursor glass composition and subjected to an aging test according to one or more embodiments described herein;

FIG. 33 is an optical image of a glass-ceramic article with an intense light shone at the edge and made from a precursor glass composition and subjected to an aging test according to one or more embodiments described herein;

FIG. 34 is an SEM image of a glass-ceramic article made from a precursor glass composition according to one or more embodiments described herein;

FIG. 35 is an EDS plot of a glass-ceramic article made from a precursor glass composition according to one or more embodiments described herein; and

FIG. 36 is an EDS plot a glass-ceramic article made from a precursor glass composition according to one or more embodiments described herein.

### DETAILED DESCRIPTION

Reference will now be made in detail to various embodiments of precursor glass compositions and glass-ceramic articles having improved mechanical durability formed therefrom. According to embodiments, a glass-ceramic article includes a crystalline phase, a residual glass phase, greater than or equal to 52 mol % and less than or equal to 70 mol % SiO₂, greater than or equal to 14 mol % and less than or equal to 35 mol % Li₂O, greater than or equal to 0.1 mol % and less than or equal to 15 mol % CaO, greater than or equal to 0.5 mol % and less than or equal to 10 mol % ZrO₂; and greater than or equal to 0.5 mol % and less than or equal to 5 mol % P₂O₅. Various embodiments of precursor glass compositions and methods of forming ion exchangeable glass-ceramic articles therefrom will be referred to herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

The term “substantially free,” when used to describe the concentration and/or absence of a particular constituent component in a precursor glass composition and the resultant glass-ceramic article, means that the constituent component is not intentionally added to the precursor glass composition and the resultant glass-ceramic article. However, the precursor glass composition and the resultant glass-ceramic article may contain traces of the constituent component as a contaminant or tramp in amounts of less than 0.1 mol %.

The terms “0 mol %” and “free,” when used to describe the concentration and/or absence of a particular constituent component in a precursor glass composition and the resultant glass-ceramic article, means that the constituent component is not present in precursor glass composition and the resultant glass-ceramic article.

In embodiments of the precursor glass compositions and the resultant glass-ceramic articles described herein, the concentrations of constituent components (e.g., SiO₂, Al₂O₃, and the like) are specified in mole percent (mol %) on an oxide basis, unless otherwise specified.

In embodiments of the precursor glass compositions and the resultant glass-ceramic articles described herein, the concentrations of F⁻ are specified in mole percent (mol %), unless otherwise specified.

The term “fracture toughness,” as used herein, refers to the K_{lc} value, and is measured using the double torsion technique described in ASTM STP 559, entitled, “Double Torsion Technique as a Universal Fracture Toughness Test Method,” the contents of which are incorporated herein by reference in their entirety.

Transmittance data (total transmittance and diffuse transmittance) is measured with a Lambda 950 UV/Vis Spectrophotometer manufactured by PerkinElmer Inc. (Waltham, Mass. USA). The Lambda 950 apparatus was fitted with a 150 mm integrating sphere. Data was collected using an open beam baseline and a Spectralon® reference reflectance disk. For total transmittance (Total Tx), the sample is fixed at the integrating sphere entry point. For diffuse transmittance (Diffuse Tx), the Spectralon® reference reflectance disk over the sphere exit port is removed to allow on-axis light to exit the sphere and enter a light trap. A zero offset measurement is made, with no sample, of the diffuse portion to determine efficiency of the light trap. To correct diffuse transmittance measurements, the zero offset contribution is subtracted from the sample measurement using the equation: Diffuse Tx=Diffuse Measured−(Zero Offset*(Total Tx/100)). The scatter ratio is measured for all wavelengths as: (% Diffuse Tx/% Total Tx).

X-ray diffraction (XRD) spectrum, as described herein, is measured with a D8 ENDEAVOR X-ray Diffraction system with a LYNXEYE XE-T detector manufactured by Bruker Corporation (Billerica, Mass.).

Electron diffraction images using scanning electron microscopy (SEM), as shown and described herein, are taken with a ZEISS Gemini SEM 500 Scanning Electron Microscope.

X-ray spectroscopy (EDS), as described herein, is collected using Bruker Esprit software by integrating short exposure (8 μm per pixel) maps for an extended period of total time. EDS data is collected using the nanoprobe SEM configuration of electron optics.

The term “average transmittance,” as used herein, refers to the average of transmittance measurements made within a given wavelength range with each whole numbered wavelength weighted equally. In embodiments described herein, the “average transmittance” is reported over the wavelength range from 400 nm to 800 nm (inclusive of endpoints).

The term “transparent,” when used to describe a glass-ceramic article formed of a precursor glass composition described herein, means that the glass-ceramic article has an average transmittance of greater than or equal to 85% when measured at normal incidence for light in a wavelength range from 400 nm to 800 nm (inclusive of endpoints) at an article thickness of 0.8 mm.

The term “transparent haze,” when used to describe a glass-ceramic article formed of a precursor glass composition described herein, means that the glass-ceramic article has an average transmittance of greater than or equal to 50% and less than 85% when measured at normal incidence for light in a wavelength range from 400 nm to 800 nm (inclusive of endpoints) at an article thickness of 0.8 mm.

The term “translucent,” when used to describe a glass-ceramic article formed of a precursor glass composition described herein, means that the glass-ceramic article has an average transmittance greater than or equal to 20% and less than 50% when measured at normal incidence for light in a wavelength range from 400 nm to 800 nm (inclusive of endpoints) at an article thickness of 0.8 mm.

The term “opaque,” when used to describe a glass-ceramic article formed of precursor glass composition described herein, means that the glass-ceramic article has an average transmittance less than 20% when measured at normal incidence for light in a wavelength range from 400 nm to 800 nm (inclusive of endpoints) at an article thickness of 0.8 mm.

The term “melting point,” as used herein, refers to the temperature at which the viscosity of the precursor glass composition is 200 poise.

The term “softening point,” as used herein, refers to the temperature at which the viscosity of the precursor glass composition is 1×10^{7.6} poise. The softening point is measured according to the parallel plate viscosity method which measures the viscosity of inorganic glass from 10⁷ to 10⁹ poise as a function of temperature, similar to ASTM C1351M.

The term “liquidus viscosity,” as used herein, refers to the viscosity of the precursor glass composition at the onset of devitrification (i.e., at the liquidus temperature as determined with the gradient furnace method according to ASTM C829-81).

The term “liquidus temperature,” as used herein, refers to the temperature at which the precursor glass composition begins to devitrify as determined with the gradient furnace method according to ASTM C829-81.

The elastic modulus (also referred to as Young's modulus) of the glass-ceramic article, as described herein, is provided in units of gigapascals (GPa) and is measured in accordance with ASTM C623.

The shear modulus of the glass-ceramic article, as described herein, is provided in units of gigapascals (GPa) and is measured in accordance with ASTM C623.

Poisson's ratio, as described herein is measured in accordance with ASTM C623.

The term “linear coefficient of thermal expansion” and “CTE,” as described herein, is measured in accordance with ASTM E228-85 over the temperature range of 25° C. to 300° C. and is expressed in terms of “×10⁻⁷/° C.”

Surface compressive stress is measured with a surface stress meter (FSM) such as commercially available instruments such as the FSM-6000, manufactured by Orihara Industrial Co., Ltd. (Japan). Surface stress measurements rely upon the measurement of the stress optical coefficient (SOC), which is related to the birefringence of the glass-ceramic article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. Depth of compression (DOC) is measured with the FSM in conjunction with a scatter light polariscope (SCALP) technique known in the art. FSM measures the depth of compression for potassium ion exchange and SCALP measures the depth of compression for sodium ion exchange. The maximum central tension (CT) values are measured using a SCALP technique known in the art. The values reported for central tension (CT) herein refer to the maximum central tension unless otherwise indicated.

The term “depth of compression” and “DOC” refer to the position in the glass-ceramic article where compressive stress transitions to tensile stress.

The stored strain energy Σ₀, as described herein, may be calculated according to the following equation (I):

$${\sum }_{0} = \frac{1 - v}{2 E} {\int }_{- {z}^{*}}^{+ {z}^{*}} ( {σ}_{x}^{2} + {σ}_{y}^{2} ) d z = \frac{1 - v}{2 E} {\int }_{- {z}^{*}}^{+ {z}^{*}} ( 2 {σ}^{2} ) d z \qquad ( I )$$

wherein z*=0.5t−σ, t is the thickness of the glass-ceramic article, σ is the depth of compression, ν is Poisson's ratio, E is Young's modulus (in MPa), and σ is tensile stress (in MPa). The integration is computed across the thickness (in micrometers) of the tensile region only.

As used herein, the “frangibility limit” refers to the central tension or stored strain energy above which the glass-ceramic article exhibits frangible behavior. “Frangibility” or “frangible behavior” refers to specific fracture behavior when a glass-ceramic article is subjected to an impact or insult. As utilized herein, a glass-ceramic article is considered non-frangible when it exhibits at least one of the following in a test area as a result of a frangibility test: (1) four or less fragments with a largest dimension of at least 1 mm, and/or (2) the number of bifurcations is less than or equal to the number of crack branches. The fragments, bifurcations, and crack branches are counted based on any 2 inch by 2 inch square centered on the impact point. Thus, a glass-ceramic article is considered non-frangible if it meets one or both of tests (1) and (2) for any 2 inch by 2 inch square centered on the impact point where the breakage is created according to the procedure described below. In a frangibility test, an impact probe is brought in to contact with the glass-ceramic article, with the depth to which the impact probe extends into the glass-ceramic article increasing in successive contact iterations. The step-wise increase in depth of the impact probe allows the flaw produced by the impact probe to reach the tension region while preventing the application of excessive external force that would prevent the accurate determination of the frangible behavior of the glass-ceramic article. In embodiments, the depth of the impact probe in the glass-ceramic article may increase by about 5 μm in each iteration, with the impact probe being removed from contact with the glass-ceramic article between each iteration. The test area is any 2 inch by 2 inch square centered at the impact point.

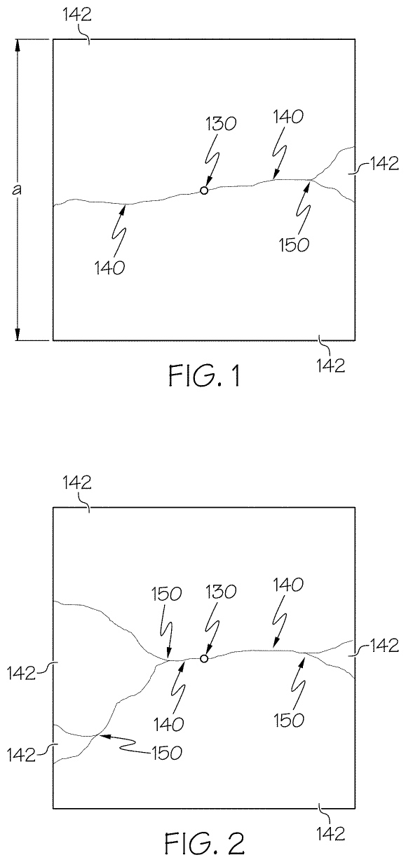

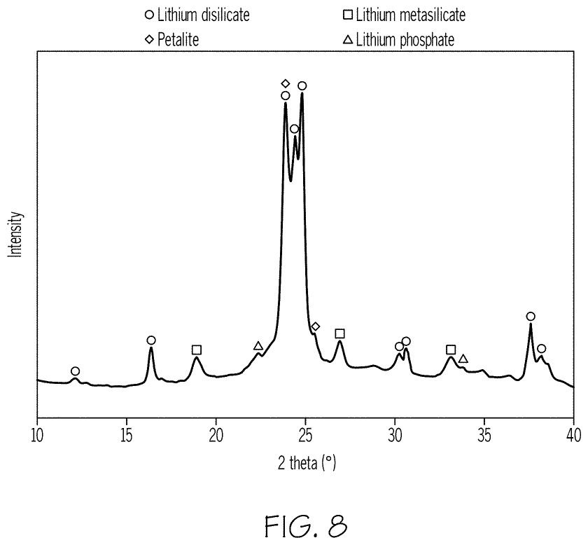

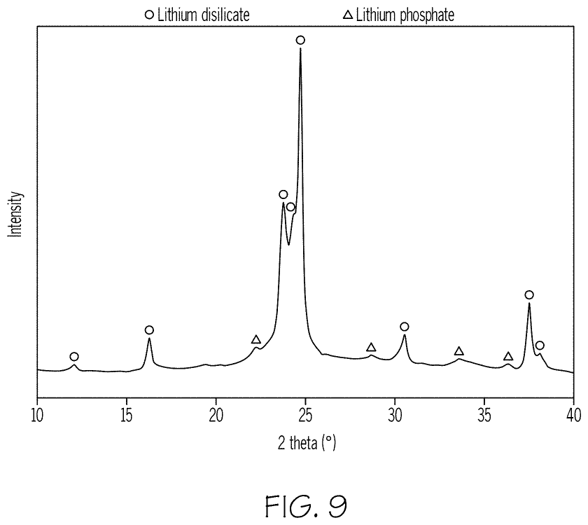

FIG. 1 depicts a non-frangible test result. As shown in FIG. 9, the test area is a square that is centered at the impact point 130, where the length of a side of the square a is 2 inches. The non-frangible sample shown in FIG. 9 includes three fragments 142, two crack branches 140, and a single bifurcation 150. Thus, the non-frangible sample shown in FIG. 9 contains less than four fragments having a largest dimension of at least 1 mm and the number of bifurcations is less than or equal to the number of crack branches. As utilized herein, a crack branch originates at the impact point, and a fragment is considered to be within the test area is any part of the fragment extends into the test area. While coatings, adhesive layers, and the like may be used in conjunction with the glass-ceramic articles described herein, such external restraints are not used in determining the frangibility or frangible behavior of the glass-ceramic articles. In embodiments, a film that does not affect the fracture behavior of the glass-ceramic article may be applied to the glass-ceramic article prior to the frangibility test to prevent the ejection of fragments from the glass-ceramic article, increasing safety for the person performing the test.

A frangible sample is depicted in FIG. 2. The frangible sample includes five fragments 142 having crack branches 140 and three bifurcations 150, producing more bifurcations than crack branches. Thus, the sample depicted in FIG. 2 does not exhibit either four or less fragments or the number of bifurcations being less than or equal to the number of crack branches.

In the frangibility test described herein, the impact is delivered to the surface of the glass-ceramic article with a force that is just sufficient to release the internally stored energy present within the strengthened glass article. That is, the point impact force is sufficient to create at least one new crack at the surface of the strengthened glass sheet and extend the crack through the compressive stress layer into the region that is under central tension (CT).

The term “grain size,” as used herein, refers to the size of the largest dimension of the grain as measured using scanning electron microscopy as described in M. N. Rahaman, “Ceramic Processing,” CRC Press, 2007, pp. 107.

The term “aspect ratio,” as used herein, refers to the average ratio of the largest dimension and the smallest dimension orthogonal to it in the grain as measured using scanning electron microscopy as described in M. N. Rahaman, “Ceramic Processing,” CRC Press, 2007, pp. 107).

The term “precursor glass composition,” as used herein, refers to a glass composition which, upon heat treatment, may form a precursor glass article or a glass-ceramic article.

The term “precursor glass article,” as used herein, refers to a glass article containing one or more nucleating agents which, upon heat treatment, causes the nucleation of a crystalline phase in the glass.

The term “glass-ceramic article,” as used herein, refers to an article formed from heat treating a glass article formed from a precursor glass composition to induce nucleation of the crystalline phase, such that the glass-ceramic article includes the crystalline phase and a residual glass phase. In embodiments, the glass-ceramic articles have about 1% to about 99% crystallinity.

For ease of reading, the term “precursor glass composition” is referred to throughout the Detailed Description. However, it should be appreciated that the glass-ceramic articles described herein are produced by heat treating a precursor glass article formed from the precursor glass composition.

Glass-ceramic articles generally have improved fracture toughness relative to articles formed from glass due to the presence of crystalline grains, which impede crack growth, and the relatively high elastic modulus of the glass-ceramic articles. However, because of the microstructure inherent to glass-ceramic articles, it may be difficult to achieve the desired transparency. Moreover, alkali oxides present in the precursor glass composition may be included in the crystalline phase after heat treatment and may not be available for ion exchange.

Disclosed herein are precursor glass compositions and glass-ceramic articles formed therefrom which mitigate the aforementioned problems. Specifically, the precursor glass compositions described herein comprise relatively high concentrations of Li₂O, CaO, ZrO₂, and P₂O₅ and may be subjected to certain heat treatments to form lithium disilicate glass-ceramic articles characterized as transparent or transparent haze. The lithium disilicate nanocrystals have an interlocking microstructure, which may aid in improving the fracture toughness of the glass-ceramic article. “Interlocking microstructure” means elongated and randomly oriented nanocrystals that are engaged and intertwined with each other. This interlocking structure creates a tortuous path for and impedes crack propagation. Moreover, the relatively large amount of lithium disilicate (e.g., present in a greater amount, based on a total weight of the crystalline phase, than any other crystalline phase) may result in a relatively high elastic modulus compared to articles formed from glass alone. The glass-ceramic articles have a relatively high amount of Li₂O present in the residual glass phase. Thus, the residual glass phase may be readily ion exchanged to achieve a relatively high maximum central tension and stored strain energy without being frangible.

The precursor glass compositions and glass-ceramic articles described herein may be described as lithium silicate precursor glass compositions and glass-ceramic articles and comprise SiO₂ and Li₂O. In addition to SiO₂ and Li₂O, the precursor glass compositions and glass-ceramic articles described herein further include ZrO₂ and P₂O₅ to achieve crystalline phases including the desired lithium disilicate phase. The precursor glass compositions and glass-ceramic articles described herein further include CaO to improve the melting behavior of the precursor glass composition.

SiO₂ is the primary glass former in the precursor glass compositions described herein and may function to stabilize the network structure of the glass-ceramic articles. The concentration of SiO₂ in the precursor glass compositions should be sufficiently high (e.g., greater than or equal to 52 mol %) to form a crystalline phase including lithium disilicate when the precursor glass composition is subjected to heat treatment to convert the precursor glass composition to a glass-ceramic article. The concentration of SiO₂ may be limited (e.g., less than or equal to 70 mol %) to control the melting point of the precursor glass composition, as the melting temperature of pure SiO₂ or high SiO₂ glasses is undesirably high. Thus, limiting the concentration of SiO₂ may aid in improving the meltability and the formability of the resulting glass-ceramic article.

Accordingly, in embodiments, the precursor glass composition and the resultant glass-ceramic article may comprise greater than or equal to 52 mol % and less than or equal to 70 mol % SiO₂. In embodiments, the concentration of SiO₂ in the precursor glass composition and the resultant glass-ceramic article may be greater than or equal to 52 mol %, greater than or equal to 54 mol %, or even greater than or equal to 56 mol %. In embodiments, the concentration of SiO₂ in the precursor glass composition and the resultant glass-ceramic article may be less than or equal to 70 mol %, less than or equal to 66 mol %, or even less than or equal to 62 mol %. In embodiments, the concentration of SiO₂ in the precursor glass composition and the resultant glass-ceramic article may be may be greater than or equal to 52 mol % and less than or equal to 70 mol %, greater than or equal to 52 mol % and less than or equal to 66 mol %, greater than or equal to 52 mol % and less than or equal to 62 mol %, greater than or equal to 54 mol % and less than or equal to 70 mol %, greater than or equal to 54 mol % and less than or equal to 66 mol %, greater than or equal to 54 mol % and less than or equal to 62 mol %, greater than or equal to 56 mol % and less than or equal to 70 mol %, greater than or equal to 56 mol % and less than or equal to 66 mol %, or even greater than or equal to 56 mol % and less than or equal to 62 mol %, or any and all sub-ranges formed from any of these endpoints.

Li₂O is a constituent in lithium disilicate and is included in the precursor glass compositions described herein to achieve this desired phase. Li₂O also aids in the ion exchangeability of the resulting glass-ceramic article. Li₂O reduces the softening point of the precursor glass composition thereby increasing the formability of the resulting glass-ceramic article. The concentration of Li₂O should be sufficiently high (e.g., greater than or equal to 14 mol %) such that the resulting glass-ceramic article has lithium disilicate present in a greater amount as compared to other crystalline phases, based on a total weight of the crystalline phases. However, if the concentration of Li₂O is too high (e.g., greater than 35 mol %), the viscosity of the melt may increase undesirably, thereby diminishing the formability of the resulting precursor glass and glass-ceramic article.

Accordingly, in embodiments, the precursor glass composition and the resultant glass-ceramic article may comprise greater than or equal to 14 mol % and less than or equal to 35 mol % Li₂O. In embodiments, the precursor glass composition and the resultant glass-ceramic article may comprise greater than or equal to 18 mol % and less than or equal to 32 mol % Li₂O. In embodiments, the concentration of Li₂O in the precursor glass composition and the resultant glass-ceramic article may be greater than or equal to 14 mol %, greater than or equal to 15 mol %, greater than or equal to 16 mol %, greater than or equal to 17 mol %, greater than or equal to 18 mol %, greater than or equal to 19 mol %, greater than or equal to 20 mol %, greater than or equal to 21 mol %, greater than or equal to 22 mol %, greater than or equal to 23 mol %, or even greater than or equal to 24 mol %. In embodiments, the concentration of Li₂O in the precursor glass composition and the resultant glass-ceramic article may be less than or equal to 35 mol %, less than or equal to 33 mol %, less than or equal to 30 mol %, less than or equal to 29 mol %, less than or equal to 28 mol %, less than or equal to 27 mol %, or even less than or equal to 26 mol %. In embodiments, the concentration of Li₂O in the precursor glass composition and the resultant glass-ceramic article may be greater than or equal to 14 mol % and less than or equal to 35 mol %, greater than or equal to 14 mol % and less than or equal to 33 mol %, greater than or equal to 14 mol % and less than or equal to 30 mol %, greater than or equal to 14 mol % and less than or equal to 29 mol %, greater than or equal to 14 mol % and less than or equal to 28 mol %, greater than or equal to 14 mol % and less than or equal to 27 mol %, greater than or equal to 14 mol % and less than or equal to 26 mol %, greater than or equal to 15 mol % and less than or equal to 35 mol %, greater than or equal to 15 mol % and less than or equal to 33 mol %, greater than or equal to 15 mol % and less than or equal to 30 mol %, greater than or equal to 15 mol % and less than or equal to 29 mol %, greater than or equal to 15 mol % and less than or equal to 28 mol %, greater than or equal to 15 mol % and less than or equal to 27 mol %, greater than or equal to 15 mol % and less than or equal to 26 mol %, greater than or equal to 16 mol % and less than or equal to 35 mol %, greater than or equal to 16 mol % and less than or equal to 33 mol %, greater than or equal to 16 mol % and less than or equal to 30 mol %, greater than or equal to 16 mol % and less than or equal to 29 mol %, greater than or equal to 16 mol % and less than or equal to 28 mol %, greater than or equal to 16 mol % and less than or equal to 27 mol %, greater than or equal to 16 mol % and less than or equal to 26 mol %, greater than or equal to 17 mol % and less than or equal to 35 mol %, greater than or equal to 17 mol % and less than or equal to 33 mol %, greater than or equal to 17 mol % and less than or equal to 30 mol %, greater than or equal to 17 mol % and less than or equal to 29 mol %, greater than or equal to 17 mol % and less than or equal to 28 mol %, greater than or equal to 17 mol % and less than or equal to 27 mol %, greater than or equal to 17 mol % and less than or equal to 26 mol %, greater than or equal to 18 mol % and less than or equal to 35 mol %, greater than or equal to 18 mol % and less than or equal to 33 mol %, greater than or equal to 18 mol % and less than or equal to 30 mol %, greater than or equal to 18 mol % and less than or equal to 29 mol %, greater than or equal to 18 mol % and less than or equal to 28 mol %, greater than or equal to 18 mol % and less than or equal to 27 mol %, greater than or equal to 18 mol % and less than or equal to 26 mol %, greater than or equal to 19 mol % and less than or equal to 35 mol %, greater than or equal to 19 mol % and less than or equal to 33 mol %, greater than or equal to 19 mol % and less than or equal to 30 mol %, greater than or equal to 19 mol % and less than or equal to 29 mol %, greater than or equal to 19 mol % and less than or equal to 28 mol %, greater than or equal to 19 mol % and less than or equal to 27 mol %, greater than or equal to 19 mol % and less than or equal to 26 mol %, greater than or equal to 20 mol % and less than or equal to 35 mol %, greater than or equal to 20 mol % and less than or equal to 33 mol %, greater than or equal to 20 mol % and less than or equal to 30 mol %, greater than or equal to 20 mol % and less than or equal to 29 mol %, greater than or equal to 20 mol % and less than or equal to 28 mol %, greater than or equal to 20 mol % and less than or equal to 27 mol %, greater than or equal to 20 mol % and less than or equal to 26 mol %, greater than or equal to 21 mol % and less than or equal to 35 mol %, greater than or equal to 21 mol % and less than or equal to 33 mol %, greater than or equal to 21 mol % and less than or equal to 30 mol %, greater than or equal to 21 mol % and less than or equal to 29 mol %, greater than or equal to 21 mol % and less than or equal to 28 mol %, greater than or equal to 21 mol % and less than or equal to 27 mol %, greater than or equal to 21 mol % and less than or equal to 26 mol %, greater than or equal to 22 mol % and less than or equal to 35 mol %, greater than or equal to 22 mol % and less than or equal to 33 mol %, greater than or equal to 22 mol % and less than or equal to 30 mol %, greater than or equal to 22 mol % and less than or equal to 29 mol %, greater than or equal to 22 mol % and less than or equal to 28 mol %, greater than or equal to 22 mol % and less than or equal to 27 mol %, greater than or equal to 22 mol % and less than or equal to 26 mol %, greater than or equal to 23 mol % and less than or equal to 35 mol %, greater than or equal to 23 mol % and less than or equal to 33 mol %, greater than or equal to 23 mol % and less than or equal to 30 mol %, greater than or equal to 23 mol % and less than or equal to 29 mol %, greater than or equal to 23 mol % and less than or equal to 28 mol %, greater than or equal to 23 mol % and less than or equal to 27 mol %, greater than or equal to 23 mol % and less than or equal to 26 mol %, greater than or equal to 24 mol % and less than or equal to 35 mol %, greater than or equal to 24 mol % and less than or equal to 33 mol %, greater than or equal to 24 mol % and less than or equal to 30 mol %, greater than or equal to 24 mol % and less than or equal to 29 mol %, greater than or equal to 24 mol % and less than or equal to 28 mol %, greater than or equal to 24 mol % and less than or equal to 27 mol %, or even greater than or equal to 24 mol % and less than or equal to 26 mol %, or any and all sub-ranges formed from any of these endpoints.

In embodiments, a molar ratio of the concentration of Li₂O in the precursor glass composition and the resultant glass-ceramic article to the concentration of SiO₂ in the precursor glass composition and the resultant glass-ceramic article ((i.e., Li₂O (mol %) to SiO₂ (mol %)) may be greater than or equal to 0.2 and less than or equal to 0.7 to achieve a crystalline phase including the desired lithium disilicate. In embodiments, the molar ratio of Li₂O to SiO₂ in the precursor glass composition and the resultant glass-ceramic article may be greater than or equal to 0.2, greater than or equal to 0.3, greater than or equal to 0.35, or even greater than or equal to 0.4. In embodiments, the molar ratio of Li₂O to SiO₂ in the precursor glass composition and the resultant glass-ceramic article may be less than or equal to 0.7, less than or equal to 0.6, less than or equal to 0.5, or even less than or equal to 0.45. In embodiments, the molar ratio of Li₂O to SiO₂ in the precursor glass composition and the resultant glass-ceramic article may be greater than or equal to 0.2 and less than or equal to 0.7, greater than or equal to 0.2 and less than or equal to 0.6, greater than or equal to 0.2 and less than or equal to 0.5, greater than or equal to 0.2 and less than or equal to 0.45, greater than or equal to 0.3 and less than or equal to 0.7, greater than or equal to 0.3 and less than or equal to 0.6, greater than or equal to 0.3 and less than or equal to 0.5, greater than or equal to 0.3 and less than or equal to 0.45, greater than or equal to 0.35 and less than or equal to 0.7, greater than or equal to 0.35 and less than or equal to 0.6, greater than or equal to 0.35 and less than or equal to 0.5, greater than or equal to 0.35 and less than or equal to 0.45, greater than or equal to 0.4 and less than or equal to 0.7, greater than or equal to 0.4 and less than or equal to 0.6, greater than or equal to 0.4 and less than or equal to 0.5, or even greater than or equal to 0.4 and less than or equal to 0.45, or any and all sub-ranges formed from any of these endpoints.

The precursor glass compositions and the resultant glass-ceramic articles described herein may further comprise alkali metal oxides other than Li₂O, such as Na₂O and/or K₂O. In addition to aiding in ion exchangeability of the resulting glass-ceramic article, Na₂O decreases the melting point and improves formability of the resulting glass-ceramic article. In embodiments, the precursor glass composition and the resultant glass-ceramic article may comprise greater than or equal to 0 mol % and less than or equal to 5 mol % Na₂O. In embodiments, the concentration of Na₂O in the precursor glass composition and the resultant glass-ceramic article may be greater than or equal to 0 mol %, greater than or equal to 0.5 mol %, or even greater than or equal to 1 mol %. In embodiments, the concentration of Na₂O in the precursor glass composition and the resultant glass-ceramic article may be less than or equal to 5 mol %, less than or equal to 4 mol %, less than or equal to 3 mol %, or even less than or equal to 2 mol %. In embodiments, the concentration of Na₂O in the precursor glass composition and the resultant glass-ceramic article may be greater than or equal to 0 mol % and less than or equal to 5 mol %, greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0.5 mol % and less than or equal to 5 mol %, greater than or equal to 0.5 mol % and less than or equal to 4 mol %, greater than or equal to 0.5 mol % and less than or equal to 3 mol %, greater than or equal to 0.5 mol % and less than or equal to 2 mol %, greater than or equal to 1 mol % and less than or equal to 5 mol %, greater than or equal to 1 mol % and less than or equal to 4 mol %, greater than or equal to 1 mol % and less than or equal to 3 mol %, or even greater than or equal to 1 mol % and less than or equal to 2 mol %, or any and all sub-ranges formed from any of these endpoints. In embodiments, the precursor glass compositions and the resultant glass-ceramic articles may be substantially free or free of Na₂O.

K₂O promotes ion exchange, increases the depth of compression and decreases the melting point to improve formability of the resulting glass-ceramic article. However, adding K₂O may cause the surface compressive stress and melting point to be too low. In embodiments, the precursor glass composition and the resultant glass-ceramic article may comprise greater than or 0 mol % and less than or equal to 5 mol % K₂O. In embodiments, the concentration of K₂O in the precursor glass composition and the resultant glass-ceramic article may be greater than or equal to 0 mol %, greater than or equal to 0.5 mol %, or even greater than or equal to 1 mol %. In embodiments, the concentration of K₂O in the precursor glass composition and the resultant glass-ceramic article may be less than or equal to 5 mol %, less than or equal to 4 mol %, less than or equal to 3 mol %, or even less than or equal to 2 mol %. In embodiments, the concentration of K₂O in the precursor glass composition and the resultant glass-ceramic article may be greater than or equal to 0 mol % and less than or equal to 5 mol %, greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0.5 mol % and less than or equal to 5 mol %, greater than or equal to 0.5 mol % and less than or equal to 4 mol %, greater than or equal to 0.5 mol % and less than or equal to 3 mol %, greater than or equal to 0.5 mol % and less than or equal to 2 mol %, greater than or equal to 1 mol % and less than or equal to 5 mol %, greater than or equal to 1 mol % and less than or equal to 4 mol %, greater than or equal to 1 mol % and less than or equal to 3 mol %, or even greater than or equal to 1 mol % and less than or equal to 2 mol %, or any and all sub-ranges formed from any of these endpoints. In embodiments, the precursor glass compositions and the resultant glass-ceramic articles may be substantially free or free of K₂O.

As used herein, R₂O is the sum (in mol %) of Li₂O, Na₂O, and K₂O (i.e., R₂O=Li₂O (mol %)+Na₂O (mol %)+K₂O (mol %)) present in the precursor glass composition and the resultant glass-ceramic article. Alkali oxides, such as Li₂O, Na₂O, and K₂O, aid in decreasing the softening point and molding temperature of the precursor glass composition, thereby offsetting the increase in the softening point and molding temperature of the precursor glass composition due to higher amounts of SiO₂ in the precursor glass composition. The decrease in the softening point and molding temperature may be further reduced by including combinations of alkali oxides (e.g., two or more alkali oxides) in the precursor glass composition, a phenomenon referred to as the “mixed alkali effect.” However, it has been found that if the amount of alkali oxide is too high, the average coefficient of thermal expansion of the precursor glass composition increases to greater than 100×10⁻⁷° C., which may be undesirable.

In embodiments, the concentration of R₂O in the precursor glass composition and the resultant glass-ceramic article may be greater than or equal to 14 mol % and less than or equal to 40 mol %. In embodiments, the concentration of R₂O in the precursor glass composition and the resultant glass-ceramic article may be greater than or equal to 14 mol %, greater than or equal to 16 mol %, greater than or equal to 18 mol %, greater than or equal to 20 mol %, greater than or equal to 22 mol %, greater than or equal to 24 mol %, or even greater than or equal to 26 mol %. In embodiments, the concentration of R₂O in the precursor glass composition and the resultant glass-ceramic article may be less than or equal to 40 mol %, less than or equal to 37 mol %, less than or equal to 35 mol %, less than or equal to 33 mol %, or even less than or equal to 30 mol %. In embodiments, the concentration of R₂O in the precursor glass composition and the resultant glass-ceramic article may be greater than or equal to 14 mol % and less than or equal to 40 mol %, greater than or equal to 14 mol % and less than or equal to 37 mol %, greater than or equal to 14 mol % and less than or equal to 35 mol %, greater than or equal to 14 mol % and less than or equal to 33 mol %, greater than or equal to 14 mol % and less than or equal to 30 mol %, greater than or equal to 16 mol % and less than or equal to 40 mol %, greater than or equal to 16 mol % and less than or equal to 37 mol %, greater than or equal to 16 mol % and less than or equal to 35 mol %, greater than or equal to 16 mol % and less than or equal to 33 mol %, greater than or equal to 16 mol % and less than or equal to 30 mol %, greater than or equal to 18 mol % and less than or equal to 40 mol %, greater than or equal to 18 mol % and less than or equal to 37 mol %, greater than or equal to 18 mol % and less than or equal to 35 mol %, greater than or equal to 18 mol % and less than or equal to 33 mol %, greater than or equal to 18 mol % and less than or equal to 30 mol %, greater than or equal to 20 mol % and less than or equal to 40 mol %, greater than or equal to 20 mol % and less than or equal to 37 mol %, greater than or equal to 20 mol % and less than or equal to 35 mol %, greater than or equal to 20 mol % and less than or equal to 33 mol %, greater than or equal to 20 mol % and less than or equal to 30 mol %, greater than or equal to 22 mol % and less than or equal to 40 mol %, greater than or equal to 22 mol % and less than or equal to 37 mol %, greater than or equal to 22 mol % and less than or equal to 35 mol %, greater than or equal to 22 mol % and less than or equal to 33 mol %, greater than or equal to 22 mol % and less than or equal to 30 mol %, greater than or equal to 24 mol % and less than or equal to 40 mol %, greater than or equal to 24 mol % and less than or equal to 37 mol %, greater than or equal to 24 mol % and less than or equal to 35 mol %, greater than or equal to 24 mol % and less than or equal to 33 mol %, greater than or equal to 24 mol % and less than or equal to 30 mol %, greater than or equal to 26 mol % and less than or equal to 40 mol %, greater than or equal to 26 mol % and less than or equal to 37 mol %, greater than or equal to 26 mol % and less than or equal to 35 mol %, greater than or equal to 26 mol % and less than or equal to 33 mol %, or even greater than or equal to 26 mol % and less than or equal to 30 mol %, or any and all sub-ranges formed from any of these endpoints.

The precursor glass compositions and the resultant glass-ceramic articles described herein further comprise CaO. CaO lowers the viscosity of the precursor glass composition, which enhances the formability, the strain point and the Young's modulus of the resulting glass-ceramic article, and may improve ion exchangeability. However, when too much CaO is added to the precursor glass composition, the diffusivity of sodium and potassium ions in the precursor glass composition decreases which, in turn, adversely impacts the ion exchange performance (i.e., the ability to ion exchange) of the resultant glass-ceramic article.

In embodiments, the precursor glass composition and the resultant glass-ceramic article may comprise greater than or equal to 0.1 mol % and less than or equal to 15 mol % CaO. In embodiments, the concentration of CaO in the precursor glass composition and the resultant glass-ceramic article may be greater than or equal to 0.1 mol %, greater than or equal to 0.5 mol %, greater than or equal to 1 mol %, greater than or equal to 2 mol %, greater than or equal than or equal to 3 mol %, greater than or equal to 4 mol %, greater than or equal to 5 mol %, or even greater than or equal to 6 mol %. In embodiments, the concentration of CaO in the precursor glass composition and the resultant glass-ceramic article may be less than or equal to 15 mol %, less than or equal to 13 mol %, less than or equal to 10 mol %, less than or equal to 9 mol %, less than or equal to 8 mol %, or even less than or equal to 7 mol %. In embodiments, the concentration of CaO in the precursor glass composition and the resultant glass-ceramic article may be greater than or equal to 0.1 mol % and less than or equal to 15 mol %, greater than or equal to 0.1 mol % and less than or equal to 13 mol %, greater than or equal to 0.1 mol % and less than or equal to 10 mol %, greater than or equal to 0.1 mol % and less than or equal to 9 mol %, greater than or equal to 0.1 mol % and less than or equal to 8 mol %, greater than or equal to 0.1 mol % and less than or equal to 7 mol %, greater than or equal to 0.5 mol % and less than or equal to 15 mol %, greater than or equal to 0.5 mol % and less than or equal to 13 mol %, greater than or equal to 0.5 mol % and less than or equal to 10 mol %, greater than or equal to 0.5 mol % and less than or equal to 9 mol %, greater than or equal to 0.5 mol % and less than or equal to 8 mol %, greater than or equal to 0.5 mol % and less than or equal to 7 mol %, greater than or equal to 1 mol % and less than or equal to 15 mol %, greater than or equal to 1 mol % and less than or equal to 13 mol %, greater than or equal to 1 mol % and less than or equal to 10 mol %, greater than or equal to 1 mol % and less than or equal to 9 mol %, greater than or equal to 1 mol % and less than or equal to 8 mol %, greater than or equal to 1 mol % and less than or equal to 7 mol %, greater than or equal to 2 mol % and less than or equal to 15 mol %, greater than or equal to 2 mol % and less than or equal to 13 mol %, greater than or equal to 2 mol % and less than or equal to 10 mol %, greater than or equal to 2 mol % and less than or equal to 9 mol %, greater than or equal to 2 mol % and less than or equal to 8 mol %, greater than or equal to 2 mol % and less than or equal to 7 mol %, greater than or equal to 3 mol % and less than or equal to 15 mol %, greater than or equal to 3 mol % and less than or equal to 13 mol %, greater than or equal to 3 mol % and less than or equal to 10 mol %, greater than or equal to 3 mol % and less than or equal to 9 mol %, greater than or equal to 3 mol % and less than or equal to 8 mol %, greater than or equal to 3 mol % and less than or equal to 7 mol %, greater than or equal to 4 mol % and less than or equal to 15 mol %, greater than or equal to 4 mol % and less than or equal to 13 mol %, greater than or equal to 4 mol % and less than or equal to 10 mol %, greater than or equal to 4 mol % and less than or equal to 9 mol %, greater than or equal to 4 mol % and less than or equal to 8 mol %, greater than or equal to 4 mol % and less than or equal to 7 mol %, greater than or equal to 5 mol % and less than or equal to 15 mol %, greater than or equal to 5 mol % and less than or equal to 13 mol %, greater than or equal to 5 mol % and less than or equal to 10 mol %, greater than or equal to 5 mol % and less than or equal to 9 mol %, greater than or equal to 5 mol % and less than or equal to 8 mol %, greater than or equal to 5 mol % and less than or equal to 7 mol %, greater than or equal to 6 mol % and less than or equal to 15 mol %, greater than or equal to 6 mol % and less than or equal to 13 mol %, greater than or equal to 6 mol % and less than or equal to 10 mol %, greater than or equal to 6 mol % and less than or equal to 9 mol %, greater than or equal to 6 mol % and less than or equal to 8 mol %, or even greater than or equal to 6 mol % and less than or equal to 7 mol %, or any and all sub-ranges formed from any of these endpoints.

The precursor glass compositions and the resultant glass-ceramic articles described herein may further comprise divalent cation oxides other than CaO, such as MgO, ZnO, SrO, and/or BaO. In embodiments, the precursor glass composition and the resultant glass-ceramic article may comprise greater than or equal to 0 mol % and less than or equal to 6 mol % MgO. In embodiments, the concentration of MgO in the precursor glass composition and the resultant glass-ceramic article may be greater than or equal to 0 mol %, greater than or equal to 1 mol %, greater than or equal to 2 mol %, or even greater than or equal to 3 mol %. In embodiments, the concentration of MgO in the precursor glass composition and the resultant glass-ceramic article may be less than or equal to 6 mol %, less than or equal to 5 mol %, or even less than or equal to 4 mol %. In embodiments, the concentration of MgO in the precursor glass composition and the resultant glass-ceramic article may be greater than or equal to 0 mol % and less than or equal to 6 mol %, greater than or equal to 0 mol % and less than or equal to 5 mol %, greater than or equal to 0 mol % and less than or equal to 4 mol %, greater than or equal to 1 mol % and less than or equal to 6 mol %, greater than or equal to 1 mol % and less than or equal to 5 mol %, greater than or equal to 1 mol % and less than or equal to 4 mol %, greater than or equal to 2 mol % and less than or equal to 6 mol %, greater than or equal to 2 mol % and less than or equal to 5 mol %, greater than or equal to 2 mol % and less than or equal to 4 mol %, greater than or equal to 3 mol % and less than or equal to 6 mol %, greater than or equal to 3 mol % and less than or equal to 5 mol %, or even greater than or equal to 3 mol % and less than or equal to 4 mol %, or any and all sub-ranges formed from any of these endpoints. In embodiments, the precursor glass compositions and the resultant glass-ceramic articles may be substantially free or free of MgO.

In embodiments, the precursor glass composition and the resultant glass-ceramic article may comprise greater than or equal to 0 mol % and less than or equal to 5 mol % ZnO. In embodiments, the concentration of ZnO in the precursor glass composition and the resultant glass-ceramic article may be greater than or equal to 0 mol %, greater than or equal to 1 mol %, or even greater than or equal to 2 mol %. In embodiments, the concentration of ZnO in the precursor glass composition and the resultant glass-ceramic article may be less than or equal to 5 mol %, less than or equal to 4 mol %, or even less than or equal to 3 mol %. In embodiments, the concentration of ZnO in the precursor glass composition and the resultant glass-ceramic article may be greater than or equal to 0 mol % and less than or equal to 5 mol %, greater than or equal to 0 mol % and less than or equal to 4 mol %, greater than or equal to 0 mol % and less than or equal to 3 mol %, greater than or equal to 1 mol % and less than or equal to 5 mol %, greater than or equal to 1 mol % and less than or equal to 4 mol %, greater than or equal to 1 mol % and less than or equal to 3 mol %, greater than or equal to 2 mol % and less than or equal to 5 mol %, greater than or equal to 2 mol % and less than or equal to 4 mol %, greater than or equal to 2 mol % and less than or equal to 3 mol %, or any and all sub-ranges formed from any of these endpoints. In embodiments, the precursor glass compositions and the resultant glass-ceramic articles may be substantially free or free of ZnO.

In embodiments, the precursor glass composition and the resultant glass-ceramic article may comprise greater than or equal to 0 mol % and less than or equal to 6 mol % SrO. In embodiments, the concentration of SrO in the precursor glass composition and the resultant glass-ceramic article may be greater than or equal to 0 mol %, greater than or equal to 1 mol %, greater than or equal to 2 mol %, or even greater than or equal to 3 mol %. In embodiments, the concentration of SrO in the precursor glass composition and the resultant glass-ceramic article may be less than or equal to 6 mol %, less than or equal to 5 mol %, or even less than or equal to 4 mol %. In embodiments, the concentration of SrO in the precursor glass composition and the resultant glass-ceramic article may be greater than or equal to 0 mol % and less than or equal to 6 mol %, greater than or equal to 0 mol % and less than or equal to 5 mol %, greater than or equal to 0 mol % and less than or equal to 4 mol %, greater than or equal to 1 mol % and less than or equal to 6 mol %, greater than or equal to 1 mol % and less than or equal to 5 mol %, greater than or equal to 1 mol % and less than or equal to 4 mol %, greater than or equal to 2 mol % and less than or equal to 6 mol %, greater than or equal to 2 mol % and less than or equal to 5 mol %, greater than or equal to 2 mol % and less than or equal to 4 mol %, greater than or equal to 3 mol % and less than or equal to 6 mol %, greater than or equal to 3 mol % and less than or equal to 5 mol %, or even greater than or equal to 3 mol % and less than or equal to 4 mol %, or any and all sub-ranges formed from any of these endpoints. In embodiments, the precursor glass compositions and the resultant glass-ceramic articles may be substantially free or free of SrO.

In embodiments, the precursor glass composition and the resultant glass-ceramic article may comprise greater than or equal to 0 mol % and less than or equal to 6 mol % BaO. In embodiments, the concentration of BaO in the precursor glass composition and the resultant glass-ceramic article may be greater than or equal to 0 mol %, greater than or equal to 1 mol %, greater than or equal to 2 mol %, or even greater than or equal to 3 mol %. In embodiments, the concentration of BaO in the precursor glass composition and the resultant glass-ceramic article may be less than or equal to 6 mol %, less than or equal to 5 mol %, or even less than or equal to 4 mol %. In embodiments, the concentration of BaO in the precursor glass composition and the resultant glass-ceramic article may be greater than or equal to 0 mol % and less than or equal to 6 mol %, greater than or equal to 0 mol % and less than or equal to 5 mol %, greater than or equal to 0 mol % and less than or equal to 4 mol %, greater than or equal to 1 mol % and less than or equal to 6 mol %, greater than or equal to 1 mol % and less than or equal to 5 mol %, greater than or equal to 1 mol % and less than or equal to 4 mol %, greater than or equal to 2 mol % and less than or equal to 6 mol %, greater than or equal to 2 mol % and less than or equal to 5 mol %, greater than or equal to 2 mol % and less than or equal to 4 mol %, greater than or equal to 3 mol % and less than or equal to 6 mol %, greater than or equal to 3 mol % and less than or equal to 5 mol %, or even greater than or equal to 3 mol % and less than or equal to 4 mol %, or any and all sub-ranges formed from any of these endpoints. In embodiments, the precursor glass compositions and the resultant glass-ceramic articles may be substantially free or free of BaO.

As used herein, R′O is the sum (in mol %) of CaO, MgO, ZnO, SrO, and BaO (i.e. R′O=CaO (mol %)+MgO (mol %)+ZnO (mol %)+SrO (mol %)+BaO (mol %)) present in the precursor glass composition and the resultant glass-ceramic article. Divalent cation oxides, such as CaO, MgO, ZnO, SrO, and BaO, lower the viscosity of the precursor glass composition, which enhances the formability, the strain point and the Young's modulus of the resulting glass-ceramic article, and may improve ion exchangeability. However, when too much divalent cation oxide is added to the precursor glass composition, the diffusivity of sodium and potassium ions in the precursor glass composition decreases which, in turn, adversely impacts the ion exchange performance (i.e., the ability to ion exchange) of the resultant glass-ceramic article.

In embodiments, the concentration of R′ 0 in the precursor glass composition and the resultant glass-ceramic article may be greater than or equal to 0.1 mol % and less than or equal to 15 mol % R′O. In embodiments, the concentration of R′O in the precursor glass composition and the resultant glass-ceramic article may be greater than or equal 0.1 mol %, greater than or equal to 0.5 mol %, greater than or equal to 1 mol %, or even greater than or equal to 2 mol %. In embodiments, the concentration of R′O in the precursor glass composition and the resultant glass-ceramic article may be less than or equal to 15 mol %, less than or equal to 13 mol %, less than or equal to 11 mol %, less than or equal to 9 mol %, or even less than or equal to 7 mol %. In embodiments, the concentration of R′O in the precursor glass composition and the resultant glass-ceramic article may be greater than or equal to 0.1 mol % and less than or equal to 15 mol %, greater than or equal to 0.1 mol % and less than or equal to 13 mol %, greater than or equal to 0.1 mol % and less than or equal to 11 mol %, greater than or equal to 0.1 mol % and less than or equal to 9 mol %, greater than or equal to 0.1 mol % and less than or equal to 7 mol %, greater than or equal to 0.5 mol % and less than or equal to 15 mol %, greater than or equal to 0.5 mol % and less than or equal to 13 mol %, greater than or equal to 0.5 mol % and less than or equal to 11 mol %, greater than or equal to 0.5 mol % and less than or equal to 9 mol %, greater than or equal to 0.5 mol % and less than or equal to 7 mol %, greater than or equal to 1 mol % and less than or equal to 15 mol %, greater than or equal to 1 mol % and less than or equal to 13 mol %, greater than or equal to 1 mol % and less than or equal to 11 mol %, greater than or equal to 1 mol % and less than or equal to 9 mol %, greater than or equal to 1 mol % and less than or equal to 7 mol %, greater than or equal to 2 mol % and less than or equal to 15 mol %, greater than or equal to 2 mol % and less than or equal to 13 mol %, greater than or equal to 2 mol % and less than or equal to 11 mol %, greater than or equal to 2 mol % and less than or equal to 9 mol %, or even greater than or equal to 2 mol % and less than or equal to 7 mol %, or any and all sub-ranges formed from any of these endpoints.

In embodiments, a molar ratio of the concentration of R′O in the precursor glass composition and the resultant glass-ceramic article to the concentration of SiO₂ in the precursor glass composition and the resultant glass-ceramic article ((i.e., R′O (mol %) to SiO₂ (mol %)) may be greater than or equal to 0 and less than or equal to 0.3 to prevent phase separation in the precursor glass composition and to produce a lithium disilicate glass-ceramic article characterized as transparent or transparent haze. If the molar ratio of R′O to SiO₂ is too high (e.g., greater than 0.3), then the formation of lithium disilicate may be suppressed. In embodiments, the molar ratio of R′O to SiO₂ in the precursor glass composition and the resultant glass-ceramic article may be greater than or equal to 0, greater than or equal to 0.05, or even greater than or equal to 0.1. In embodiments, the molar ratio of R′O to SiO₂ in the precursor glass composition and the resultant glass-ceramic article may be less than or equal to 0.3, less than or equal to 0.2, or even less than or equal to 0.15. In embodiments, the molar ratio of R′O to SiO₂ in the precursor glass composition and the resultant glass-ceramic article may be greater than or equal to 0 and less than or equal to 0.3, greater than or equal to 0 and less than or equal to 0.2, greater than or equal to 0 and less than or equal to 0.15, greater than or equal to 0.05 and less than or equal to 0.3, greater than or equal to 0.05 and less than or equal to 0.2, greater than or equal to 0.05 and less than or equal to 0.15, greater than or equal to 0.1 and less than or equal to 0.3, greater than or equal to 0.1 and less than or equal to 0.2, or even greater than or equal to 0.1 and less than or equal to 0.15, or any and all sub-ranges formed from any of these endpoints.

The precursor glass compositions and the resultant glass-ceramic articles described herein further include ZrO₂. ZrO₂ may help decrease the lithium disilicate grain size, which may be important to the formation of a transparent or transparent haze glass-ceramic articles. Like SiO₂, ZrO₂ may function as a network former, thereby improving the stability of the glass by reducing devitrification during forming and reducing liquidus temperature. The addition of ZrO₂ may also improve the chemical durability of the resulting glass-ceramic article. In embodiments, the precursor glass composition and the resultant glass-ceramic article may comprise greater than or equal to 0.5 mol % and less than or equal to 10 mol % ZrO₂. In embodiments, the precursor glass composition and the resultant glass-ceramic article may comprise greater than or equal to 0.5 mol % and less than or equal to 7 mol % ZrO₂. In embodiments, the concentration of ZrO₂ in the precursor glass composition and the resultant glass-ceramic article may be greater than or equal to 0.5 mol %, greater than or equal to 1 mol %, greater than or equal to 1.5 mol %, or even greater than or equal to 2 mol %. In embodiments, the concentration of ZrO₂ in the precursor glass composition and the resultant glass-ceramic article may be less than or equal to 10 mol %, less than or equal to 7 mol %, less than or equal to 5 mol %, or even less than or equal to 4 mol %. In embodiments, the concentration of ZrO₂ in the precursor glass composition and the resultant glass-ceramic article may be greater than or equal to 0.5 mol % and less than or equal to 10 mol %, greater than or equal to 0.5 mol % and less than or equal to 7 mol %, greater than or equal to 0.5 mol % and less than or equal to 5 mol %, greater than or equal to 0.5 mol % and less than or equal to 4 mol %, greater than or equal to 1 mol % and less than or equal to 10 mol %, greater than or equal to 1 mol % and less than or equal to 7 mol %, greater than or equal to 1 mol % and less than or equal to 5 mol %, greater than or equal to 1 mol % and less than or equal to 4 mol %, greater than or equal to 1.5 mol % and less than or equal to 10 mol %, greater than or equal to 1.5 mol % and less than or equal to 7 mol %, greater than or equal to 1.5 mol % and less than or equal to 5 mol %, greater than or equal to 1.5 mol % and less than or equal to 4 mol %, greater than or equal to 2 mol % and less than or equal to 10 mol %, greater than or equal to 2 mol % and less than or equal to 7 mol %, greater than or equal to 2 mol % and less than or equal to 5 mol %, or even greater than or equal to 2 mol % and less than or equal to 4 mol %, or any and all sub-ranges formed from any of these endpoints.

The precursor glass compositions and the resultant glass-ceramic articles described herein further include P₂O₅. P₂O₅ serves as a nucleating agent to produce bulk nucleation of the crystalline phase in the glass, thereby transforming the precursor glass composition into a glass-ceramic article. The concentration of P₂O₅ in the precursor glass compositions should be sufficiently high (i.e., greater than or equal to 0.5 mol %) to achieve crystallization. The concentration of P₂O₅ may be limited (e.g., less than or equal to 5 mol %) to reduce devitrification during forming and to reduce the liquidus temperature. In embodiments, the precursor glass composition and the resultant glass-ceramic article may comprise greater than or equal to 0.5 mol % and less than or equal to 5 mol % P₂O₅. In embodiments, the precursor glass composition and the resultant glass-ceramic article may comprise greater than or equal to 1 mol % and less than or equal to 4.5 mol % P₂O₅. In embodiments, the concentration of P₂O₅ in the precursor glass composition and the resultant glass-ceramic article may be greater than or equal to 0.5 mol %, greater than or equal to 1 mol %, greater than or equal to 1.5 mol %, or even greater than or equal to 2 mol %. In embodiments, the concentration of P₂O₅ in the precursor glass composition and the resultant glass-ceramic article may be less than or equal to 5 mol %, less than or equal to 4.5 mol %, less than or equal to 4 mol %, less than or equal to 3.5 mol %, less than or equal to 3 mol %, or even less than or equal to 2.5 mol %. In embodiments, the concentration of P₂O₅ in the precursor glass composition and the resultant glass-ceramic article may be greater than or equal to 0.5 mol % and less than or equal to 5 mol %, greater than or equal to 0.5 mol % and less than or equal to 4.5 mol % greater than or equal to 0.5 mol % and less than or equal to 4 mol %, greater than or equal to 0.5 mol % and less than or equal to 3.5 mol %, greater than or equal to 0.5 mol % and less than or equal to 3 mol %, greater than or equal to 0.5 mol % and less than or equal to 2.5 mol %, greater than or equal to 1 mol % and less than or equal to 5 mol %, greater than or equal to 1 mol % and less than or equal to 4.5 mol % greater than or equal to 1 mol % and less than or equal to 4 mol %, greater than or equal to 1 mol % and less than or equal to 3.5 mol %, greater than or equal to 1 mol % and less than or equal to 3 mol %, greater than or equal to 1 mol % and less than or equal to 2.5 mol %, greater than or equal to 1.5 mol % and less than or equal to 5 mol %, greater than or equal to 1.5 mol % and less than or equal to 4.5 mol % greater than or equal to 1.5 mol % and less than or equal to 4 mol %, greater than or equal to 1.5 mol % and less than or equal to 3.5 mol %, greater than or equal to 1.5 mol % and less than or equal to 3 mol %, greater than or equal to 1.5 mol % and less than or equal to 2.5 mol %, greater than or equal to 2 mol % and less than or equal to 5 mol %, greater than or equal to 2 mol % and less than or equal to 4.5 mol % greater than or equal to 2 mol % and less than or equal to 4 mol %, greater than or equal to 2 mol % and less than or equal to 3.5 mol %, greater than or equal to 2 mol % and less than or equal to 3 mol %, or even greater than or equal to 2 mol % and less than or equal to 2.5 mol %, or any and all sub-ranges formed from any of these endpoints.

The precursor glass compositions and the resultant glass-ceramic articles described herein may further include Al₂O₃. Like SiO₂ and ZrO₂, Al₂O₃ may also stabilize the glass network and additionally provides improved mechanical properties and chemical durability to the glass composition. The amount of Al₂O₃ may also be tailored to the control the viscosity of the glass composition. Al₂O₃ may be included such that the resultant glass composition has the desired fracture toughness (e.g., greater than or equal to 1.0 MPa·m^{1/2}). However, if the amount of Al₂O₃ is too high (e.g., greater than 7 mol %), the viscosity of the melt may increase, thereby diminishing the formability of the glass composition, and the fraction of lithium disilicate crystals may decrease to an extent that no interlocking structure may be formed.

In embodiments, the precursor glass composition and the resultant glass-ceramic article may comprise greater than or equal to 0 mol % and less than or equal to 7 mol % Al₂O₃. In embodiments, the precursor glass composition and the resultant glass-ceramic article may comprise greater than or equal to 0.5 mol % and less than or equal to 5 mol % Al₂O₃. In embodiments, the concentration of Al₂O₃ in the precursor glass composition and the resultant glass-ceramic article may be greater than or equal to 0 mol %, greater than or equal to 0.5 mol %, greater than or equal to 1 mol %, or even greater than or equal to 1.5 mol %. In embodiments, the concentration of Al₂O₃ in the precursor glass composition and the resultant glass-ceramic article may be less than or equal to 7 mol %, less than or equal to 5 mol %, or even less than or equal to 3 mol %. In embodiments, the concentration of Al₂O₃ in the precursor glass composition and the resultant glass-ceramic article may be greater than or equal to 0 mol % and less than or equal to 7 mol %, greater than or equal to 0 mol % and less than or equal to 5 mol %, greater than or equal to 0 mol % and less than or equal to 3 mol %, greater than or equal to 0.5 mol % and less than or equal to 7 mol %, greater than or equal to 0.5 mol % and less than or equal to 5 mol %, greater than or equal to 0.5 mol % and less than or equal to 3 mol %, greater than or equal to 1 mol % and less than or equal to 7 mol %, greater than or equal to 1 mol % and less than or equal to 5 mol %, greater than or equal to 1 mol % and less than or equal to 3 mol %, greater than or equal to 1.5 mol % and less than or equal to 7 mol %, greater than or equal to 1.5 mol % and less than or equal to 5 mol %, or even greater than or equal to 1.5 mol % and less than or equal to 3 mol %, or any and all sub-ranges formed from any of these endpoints. In embodiments, the precursor glass compositions and the resultant glass-ceramic articles may be substantially free or free of Al₂O₃.

In embodiments, a molar ratio of the concentration of Al₂O₃ in the precursor glass composition and the resultant glass-ceramic article to the concentration of SiO₂ in the precursor glass composition and the resultant glass-ceramic article (i.e., Al₂O₃ (mol %) to SiO₂ (mol %)) may be greater than or equal to 0 and less than or equal to 0.2 to achieve a crystalline phase including the desired lithium disilicate. In embodiments, the molar ratio of Al₂O₃ to SiO₂ in the precursor glass composition and the resultant glass-ceramic article may be greater than or equal to 0 or even greater than or equal to 0.01. In embodiments, the molar ratio of Al₂O₃ to SiO₂ in the precursor glass composition and the resultant glass-ceramic article may be less than or equal to 0.2, less than or equal to 0.1, or even less than or equal to 0.05. In embodiments, the molar ratio of Al₂O₃ to SiO₂ in the precursor glass composition and the resultant glass-ceramic article may be greater than or equal to 0 and less than or equal to 0.2, greater than or equal to 0 and less than or equal to 0.1, greater than or equal to 0 and less than or equal to 0.05, greater than or equal to 0.01 and less than or equal to 0.2, greater than or equal to 0.01 and less than or equal to 0.1, or even greater than or equal to 0.01 and less than or equal to 0.05, or any and all sub-ranges formed from any of these endpoints.

The precursor glass compositions and the resultant glass-ceramic articles described herein may further include La₂O₃. La₂O₃ may partition into the residual glass phase and increase the refractive index thereof, which may result in a better index matching with the crystalline phase to produce a transparent or transparent haze glass-ceramic article. In embodiments, the precursor glass composition and the resultant glass-ceramic article may comprise greater than or equal to 0 mol % and less than or equal to 6 mol % La₂O₃. In embodiments, the concentration of La₂O₃ in the precursor glass compositions and the resultant glass-ceramic articles may be greater than or equal to 0 mol % greater than or equal to 0.5 mol %, greater than or equal to 1 mol %, or even greater than or equal to 2 mol %. In embodiments, the concentration of La₂O₃ in the precursor glass compositions and the resultant glass-ceramic articles may be less than or equal to 6 mol %, less than or equal to 5 mol %, less than or equal to 4 mol %, or even less than or equal to 3 mol %. In embodiments, the concentration of La₂O₃ in the precursor glass compositions and the resultant glass-ceramic articles may be greater than or equal to 0 mol % and less than or equal to 6 mol %, greater than or equal to 0 mol % and less than or equal to 5 mol %, greater than or equal to 0 mol % and less than or equal to 4 mol %, greater than or equal to 0 mol % and less than or equal to 3 mol %, greater than or equal to 0.5 mol % and less than or equal to 6 mol %, greater than or equal to 0.5 mol % and less than or equal to 5 mol %, greater than or equal to 0.5 mol % and less than or equal to 4 mol %, greater than or equal to 0.5 mol % and less than or equal to 3 mol %, greater than or equal to 1 mol % and less than or equal to 6 mol %, greater than or equal to 1 mol % and less than or equal to 5 mol %, greater than or equal to 1 mol % and less than or equal to 4 mol %, greater than or equal to 1 mol % and less than or equal to 3 mol %, greater than or equal to 2 mol % and less than or equal to 6 mol %, greater than or equal to 2 mol % and less than or equal to 5 mol %, greater than or equal to 2 mol % and less than or equal to 4 mol %, or even greater than or equal to 2 mol % and less than or equal to 3 mol %, or any and all sub-ranges formed from any of these endpoints. In embodiments, the precursor glass compositions and the resultant glass-ceramic articles may be substantially free or free of La₂O₃.

The precursor glass compositions and the resultant glass-ceramic articles described herein may further include F. In embodiments, may produce fluorapatite, which may be important for biomedical applications. In embodiments, may function as a nucleating agent in the precursor glass composition. In embodiments, may be introduced in the precursor glass composition in the form of calcium fluoride. In embodiments, the precursor glass composition and the resultant glass-ceramic article may comprise greater than or equal to 0 mol % and less than or equal to 5 mol % F. In embodiments, the concentration of in the precursor glass composition and the resultant glass-ceramic article may be greater than or equal to 0 mol %, greater than or equal to 0.5 mol %, greater than or equal to 1 mol %, or even greater than or equal to 2 mol %. In embodiments, the concentration of in the precursor glass composition and the resultant glass-ceramic article may be less than or equal to 5 mol %, less than or equal to 4 mol %, or even less than or equal to 3 mol %. In embodiments, the concentration of in the precursor glass composition and the resultant glass-ceramic article may be greater than or equal to 0 mol % and less than or equal to 5 mol %, greater than or equal to 0 mol % and less than or equal to 4 mol %, greater than or equal to 0 mol % and less than or equal to 3 mol %, greater than or equal to 0.5 mol % and less than or equal to 5 mol %, greater than or equal to 0.5 mol % and less than or equal to 4 mol %, greater than or equal to 0.5 mol % and less than or equal to 3 mol %, greater than or equal to 1 mol % and less than or equal to 5 mol %, greater than or equal to 1 mol % and less than or equal to 4 mol %, greater than or equal to 1 mol % and less than or equal to 3 mol %, greater than or equal to 2 mol % and less than or equal to 5 mol %, greater than or equal to 2 mol % and less than or equal to 4 mol %, or even greater than or equal to 2 mol % and less than or equal to 3 mol %, or any and all sub-ranges formed from any of these endpoints. In embodiments, the precursor glass compositions and the resultant glass-ceramic articles may be substantially free or free of F−.

In embodiments, the precursor glass compositions and the resultant glass-ceramic articles described herein may further include tramp materials such as TiO₂, MnO, MoO₃, WO₃, Y₂O₃, CdO, As₂O₃, Sb₂O₃, and sulfur-based compounds, such as sulfates, halogens, or combinations thereof. In embodiments, the precursor glass compositions and the resultant glass-ceramic articles may be substantially free or free of individual tramp materials, a combination of tramp materials, or all tramp materials. For example, in embodiments, the precursor glass compositions and the resultant glass-ceramic articles may be substantially free or free of TiO₂, MnO, MoO₃, WO₃, Y₂O₃, CdO, As₂O₃, Sb₂O₃, and sulfur-based compounds, such as sulfates, halogens, or combinations thereof.

In embodiments, antimicrobial components, chemical fining agents, or other additional components may be included in the precursor glass compositions and the resultant glass-ceramic articles.

In embodiments, a liquidus temperature of a precursor glass composition may be greater than or equal to 900° C., greater than or equal to 950° C., or even greater than or equal to 1000° C. In embodiments, a liquidus temperature of the precursor glass composition may be less than or equal to 1200° C., less than or equal to 1150° C. or even less than or equal to 1100° C. In embodiments, a liquidus temperature of the precursor glass composition may be greater than or equal to 900° C. and less than or equal to 1200° C., greater than or equal to 900° C. and less than or equal to 1150° C., greater than or equal to 900° C. and less than or equal to 1100° C., greater than or equal to 950° C. and less than or equal to 1200° C., greater than or equal to 950° C. and less than or equal to 1150° C., greater than or equal to 950° C. and less than or equal to 1100° C., greater than or equal to 1000° C. and less than or equal to 1200° C., greater than or equal to 1000° C. and less than or equal to 1150° C., or even greater than or equal to 1000° C. and less than or equal to 1100° C., or any and all sub-ranges formed from any of these endpoints.

The precursor glass articles or the glass-ceramic articles formed therefrom as described herein described herein may be any suitable thickness, which may vary depending on the particular application of the glass-ceramic article. In embodiments, the precursor glass articles and the glass-ceramic articles formed thereform may have a thickness greater than or equal to 250 μm and less than or equal to 6 mm, greater than or equal to 250 μm and less than or equal to 4 mm, greater than or equal to 250 μm and less than or equal to 2 mm, greater than or equal to 250 μm and less than or equal to 1 mm, greater than or equal to 250 μm and less than or equal to 750 μm, greater than or equal to 250 μm and less than or equal to 500 μm, greater than or equal to 500 μm and less than or equal to 6 mm, greater than or equal to 500 μm and less than or equal to 4 mm, greater than or equal to 500 μm and less than or equal to 2 mm, greater than or equal to 500 μm and less than or equal to 1 mm, greater than or equal to 500 μm and less than or equal to 750 μm, greater than or equal to 750 μm and less than or equal to 6 mm, greater than or equal to 750 μm and less than or equal to 4 mm, greater than or equal to 750 μm and less than or equal to 2 mm, greater than or equal to 750 μm and less than or equal to 1 mm, greater than or equal to 1 mm and less than or equal to 6 mm, greater than or equal to 1 mm and less than or equal to 4 mm, greater than or equal to 1 mm and less than or equal to 2 mm, greater than or equal to 2 mm and less than or equal to 6 mm, greater than or equal to 2 mm and less than or equal to 4 mm, or even greater than or equal to 4 mm and less than or equal to 6 mm, or any and all sub-ranges formed from any of these endpoints.

As discussed hereinabove, glass-ceramic articles formed from the precursor glass compositions described herein may have an increased fracture toughness such that the glass-ceramic articles are more resistant to damage. In embodiments, the glass-ceramic article may have a K_{lc} fracture toughness as measured by a double torsion method greater than or equal to 1.0 MPa·m^{1/2}. In embodiments, the glass-ceramic article may have a K_{lc} fracture toughness as measured by a double torsion method greater than or equal to 1.0 MPa·m^{1/2}, greater than or equal to 1.1 MPa·m^{1/2}, or even greater than or equal to 1.2 MPa·m^{1/2}.

In embodiments, an elastic modulus of a glass-ceramic article may be greater than or equal to 100 GPa. In embodiments, an elastic modulus of the glass-ceramic article may be greater than or equal to 100 GPa or even greater than or equal to 110 GPa. In embodiments, an elastic modulus of the glass-ceramic article may be less than or equal to 125 GPa or even less than or equal to 115 GPa. In embodiments, an elastic modulus of the glass-ceramic article may be greater than or equal to 100 GPa and less than or equal to 125 GPa, greater than or equal to 100 GPa and less than or equal to 115 GPa, greater than or equal to 110 GPa and less than or equal to 125 GPa, or even greater than or equal to 110 GPa and less than or equal to 115 GPa, or any and all sub-ranges formed from any of these endpoints.

In embodiments, a shear modulus of a glass-ceramic article may be greater than or equal to 30 GPa or even greater than or equal to 40 GPa. In embodiments, a shear modulus of a glass-ceramic article may be less than or equal to 55 GPa or even less than or equal to 50 GPa. In embodiments, a shear modulus of a glass-ceramic article may be greater than or equal to 30 GPa and less than or equal to 55 GPa, greater than or equal to 30 GPa and less than or equal to 50 GPa, greater than or equal to 40 GPa and less than or equal to 55 GPa, or even greater than or equal to 40 GPa and less than or equal to 50 GPa, or any and all sub-ranges formed from any of these endpoints.

In embodiments, an average transmittance of a glass-ceramic article may be greater than or equal to 50% and less than or equal to 95% of light over the wavelength range of 400 nm to 800 nm as measured at an article thickness of 0.8 mm. In embodiments, an average transmittance of the glass-ceramic article may be greater than or equal to 50%, greater than or equal to 60%, greater than or equal to 70%, or even greater than or equal to 80% of light over the wavelength range of 400 nm to 800 nm as measured at an article thickness of 0.8 mm. In embodiments, an average transmittance of the glass-ceramic article may be less than or equal to 95% or even less than or equal to 90% of light over the wavelength range of 400 nm to 800 nm as measured at an article thickness of 0.8 mm. In embodiments, an average transmittance of the glass-ceramic article may be greater than or equal to 50% and less than or equal to 95%, greater than or equal to 50% and less than or equal to 90%, greater than or equal to 60% and less than or equal to 95%, greater than or equal to 60% and less than or equal to 90%, greater than or equal to 70% and less than or equal to 95%, greater than or equal to 70% and less than or equal to 90%, greater than or equal to 80% and less than or equal to 95%, or even greater than or equal to 80% and less than or equal to 90%, or any and all sub-ranges formed from any of these endpoints of light over the wavelength range of 400 nm to 800 nm as measured at an article thickness of 0.8 mm. In embodiments, the glass-ceramic article may be transparent or transparent haze.

In embodiments, a Poisson's ratio of a glass-ceramic article may be greater than or equal to 0.20 or even greater than or equal to 0.22. In embodiments, a Poisson's ratio of the glass-ceramic article may be less than or equal to 0.25 or even less than or equal to 0.23. In embodiments, a Poisson's ratio of the glass-ceramic article may be greater than or equal to 0.20 and less than or equal to 0.25, greater than or equal to 0.20 and less than or equal to 0.23, greater than or equal to 0.22 and less than or equal to 0.25, or even greater than or equal to 0.22 and less than or equal to 0.23, or any and all sub-ranges formed from any of these endpoints.

In embodiments, the glass-ceramic articles described herein are ion exchangeable to strengthen the article. In typical ion exchange processes, smaller metal ions in the glass-ceramic article are replaced or “exchanged” with larger metal ions of the same valence within a layer that is close to the outer surface of the glass-ceramic article. The replacement of smaller ions with larger ions creates a compressive stress within the layer of the glass-ceramic article. In embodiments, the metal ions are monovalent metal ions (e.g., Li⁺, Na⁺, K⁺, and the like), and ion exchange is accomplished by immersing the glass-ceramic article in a bath comprising at least one molten salt of the larger metal ion that is to replace the smaller metal ion in the glass-ceramic article. Alternatively, other monovalent ions such as Ag⁺, Tl⁺, Cu⁺, and the like may be exchanged for monovalent ions. The ion exchange process or processes that are used to strengthen the glass-ceramic article may include, but are not limited to, immersion in a single bath or multiple baths of like or different compositions with optional washing and/or annealing steps between immersions.

Upon exposure to the glass-ceramic article, the ion exchange solution (e.g., KNO₃ and/or NaNO₃ molten salt bath) may, according to embodiments, be at a temperature greater than or equal to 350° C. and less than or equal to 500° C., greater than or equal to 360° C. and less than or equal to 450° C., greater than or equal to 370° C. and less than or equal to 440° C., greater than or equal to 360° C. and less than or equal to 420° C., greater than or equal to 370° C. and less than or equal to 400° C., greater than or equal to 375° C. and less than or equal to 475° C., greater than or equal to 400° C. and less than or equal to 500° C., greater than or equal to 410° C. and less than or equal to 490° C., greater than or equal to 420° C. and less than or equal to 480° C., greater than or equal to 430° C. and less than or equal to 470° C., or even greater than or equal to 440° C. and less than or equal to 460° C., or any and all sub-ranges between the foregoing values. In embodiments, the glass-ceramic article may be exposed to the ion exchange solution for a duration greater than or equal to 2 hours and less than or equal to 24 hours, greater than or equal to 2 hours and less than or equal to 12 hours, greater than or equal to 2 hours and less than or equal to 6 hours, greater than or equal to 8 hours and less than or equal to 24 hours, greater than or equal to 6 hours and less than or equal to 24 hours, greater than or equal to 6 hours and less than or equal to 12 hours, greater than or equal to 8 hours and less than or equal to 24 hours, or even greater than or equal to 8 hours and less than or equal to 12 hours, or any and all sub-ranges formed from any of these endpoints.

The resulting compressive stress layer may have a depth (also referred to as a “depth of compression” or “DOC”) greater than or equal to 100 μm on the surface of the glass-ceramic article in 2 hours of ion exchange time. In embodiments, the glass-ceramic articles may be ion exchanged to achieve a depth of compression greater than or equal to 10 μm, greater than or equal to 20 μm, greater than or equal to 30 μm, greater than or equal to 40 μm, greater than or equal to 50 μm, greater than or equal to 60 μm, greater than or equal to 70 μm, greater than or equal to 80 μm, greater than or equal to 90 μm, or even greater than or equal to 100 μm. In embodiments, the glass-ceramic articles have a thickness “t” and may be ion exchanged to achieve a depth of compression greater than or equal to 0.25t, greater than or equal to 0.27t, or even greater than or equal to 0.30t.

The development of this surface compression layer is beneficial for achieving a better crack resistance and higher flexural strength compared to non-ion exchanged materials. The surface compression layer has a higher concentration of the ions exchanged into the glass-ceramic article in comparison to the concentration of the ions exchanged into the body (i.e., the area not including the surface compression) of the glass-ceramic article.

In embodiments, the glass-ceramic article made from a precursor glass composition described herein may have a surface compressive stress after ion exchange strengthening greater than or equal to 80 MPa, greater than or equal to 100 MPa, or even greater than or equal to 250 MPa. In embodiments, the glass-ceramic article may have a surface compressive stress after ion exchange strengthening less than or equal to 1 GPa, less than or equal to 750 MPa, or even less than or equal to 500 MPa. In embodiments, the glass-ceramic article may have a surface compressive stress after ion exchange strengthening greater than or equal to 80 MPa and less than or equal to 1 GPa, greater than or equal to 80 MPa and less than or equal to 750 MPa, greater than or equal to 80 MPa and less than or equal to 500 MPa, greater than or equal to 100 MPa and less than or equal to 1 GPa, greater than or equal to 100 MPa and less than or equal to 750 MPa, greater than or equal to 100 MPa and less than or equal to 500 MPa, greater than or equal to 250 MPa and less than or equal to 1 GPa, greater than or equal to 250 MPa and less than or equal to 750 MPa, or even greater than or equal to 250 MPa and less than or equal to 500 MPa, or any and all sub-ranges formed from any of these endpoints.

In embodiments, the glass-ceramic article made from a precursor glass composition described herein may have a central tension after ion exchange strengthening greater than or equal to 50 MPa, greater than or equal to 75 MPa, greater than or equal to 100 MPa, or even greater than or equal to 125 MPa. In embodiments, the glass-ceramic article made from a precursor glass composition described herein may have a central tension after ion exchange strengthening less than or equal to 300 MPa, less than or equal to 250 MPa, or even less than or equal to 200 MPa. In embodiments, the glass-ceramic article made from a precursor glass composition described herein may have a central tension after ion exchange strengthening greater than or equal to 50 MPa and less than or equal to 300 MPa, greater than or equal to 50 MPa and less than or equal to 250 MPa, greater than or equal to 50 MPa and less than or equal to 200 MPa, greater than or equal to 75 MPa and less than or equal to 300 MPa, greater than or equal to 57 MPa and less than or equal to 250 MPa, greater than or equal to 57 MPa and less than or equal to 200 MPa, greater than or equal to 100 MPa and less than or equal to 300 MPa, greater than or equal to 100 MPa and less than or equal to 250 MPa, greater than or equal to 100 MPa and less than or equal to 200 MPa, greater than or equal to 125 MPa and less than or equal to 300 MPa, greater than or equal to 125 MPa and less than or equal to 250 MPa, greater than or equal to 125 MPa and less than or equal to 200 MPa, or any and all sub-ranges formed from any of these endpoints.

In embodiments, the glass-ceramic article made from a precursor glass composition described herein may have a stored strain energy after ion exchange strengthening greater than or equal to 15 J/m², greater than or equal to 30 J/m², greater than or equal to 40 J/m², greater than or equal to 50 J/m², greater than or equal to 60 J/m², greater than or equal to 70 J/m², greater than or equal to 80 J/m², greater than or equal to 90 J/m², or even greater than or equal to 100 J/m².

In embodiments, the glass-ceramic articles made from precursor glass compositions described herein are formed to have high fracture toughness and high elastic modulus so as to achieve a relatively high maximum central tension and stored strain energy, while staying below the frangibility limit of the glass-ceramic article to limit the danger of ejected shards of glass upon breakage.

In embodiments, the processes for making the glass-ceramic article include heat treating a precursor glass article formed from a precursor glass composition in an oven at one or more preselected temperatures for one or more preselected times to induce glass homogenization and crystallization (i.e., nucleation and growth) of one or more crystalline phases (e.g., having one or more compositions, amounts, morphologies, sizes or size distributions, etc.). In embodiments, the heat treatment may include (i) heating a precursor glass article in an oven at a rate greater than or equal to 1° C./min and less than or equal to 10° C./min to a nucleation temperature; (ii) maintaining the precursor glass article at the nucleation temperature in the oven for time greater than or equal to 0.1 hour and less than or equal to 8 hours to produce a nucleated crystallizable glass; (iii) heating the nucleated crystallizable glass article in the oven at a rate greater than or equal to 1° C./min and less than or equal to 10° C./min to a crystallization temperature; (iv) maintaining the nucleated crystallizable glass article at the crystallization temperature in the oven for a time greater than or equal to 0.1 hour and less than or equal to 8 hours to produce the glass-ceramic article; and (v) cooling the glass-ceramic article to room temperature.

In embodiments, the precursor glass articles may be heat treated at relatively low temperatures (e.g., nucleation temperature less than or equal to 650° C. and crystallization temperature less than or equal to 800° C.) to produce transparent or transparent haze glass-ceramic articles. While not wishing to be bound by theory, it is believed that the lower temperature heat treatment limits the lithium disilicate grain size, which helps achieve a transparent or transparent haze glass-ceramic article. Specifically, grain size increases with temperature due to ion diffusion. A lower temperature may decrease the growth kinetics.

In embodiments, the nucleation temperature may be greater than or equal to 450° C., greater than or equal to 500° C., or even greater than or equal to 525° C. In embodiments, the nucleation temperature may be less than or equal to 650° C., less than or equal to 600° C., or even less than or equal to 575° C. In embodiments, the nucleation temperature may be greater than or equal to 450° C. and less than or equal to 650° C., greater than or equal to 450° C. and less than or equal to 600° C., greater than or equal to 450° C. and less than or equal to 575° C., greater than or equal to 500° C. and less than or equal to 650° C., greater than or equal to 500° C. and less than or equal to 600° C., greater than or equal to 500° C. and less than or equal to 575° C., greater than or equal to 525° C. and less than or equal to 650° C., greater than or equal to 525° C. and less than or equal to 600° C., or even greater than or equal to 525° C. and less than or equal to 575° C., or any and all sub-ranges formed from any of these endpoints.

In embodiments, the crystallization temperature may be greater than or equal to 550° C. or even greater than or equal to 600° C. In embodiments, the crystallization temperature may be less than or equal to 800° C. or even less than or equal to 700° C. In embodiments, the crystallization temperature may be greater than or equal to 550° C. and less than or equal to 800° C., greater than or equal to 550° C. and less than or equal to 700° C., greater than or equal to 600° C. and less than or equal to 800° C., or even greater than or equal to 600° C. and less than or equal to 700° C., or any and all sub-ranges formed from any of these endpoints.

As utilized herein, the heating rates, nucleation temperature, and crystallization temperature refer to the heating rate and temperature of the oven in which the precursor glass composition or precursor glass article is being heat treated.

In addition to the precursor glass compositions, temperature-temporal profiles of heat treatment steps of heating to the crystallization temperature and maintaining the temperature at the crystallization temperature are judiciously prescribed so as to produce one or more of the following desired attributes: crystalline phase(s) of the glass-ceramic article, proportions of one or more major crystalline phases and/or one or more minor crystalline phases and residual glass phases, crystal phase assemblages of one or more predominate crystalline phases and/or one or more minor crystalline phases and residual glass phases, and grain sizes or grain size distribution among one or more major crystalline phases and/or one or more minor crystalline phases, which in turn may influence the final integrity, quality, color, and/or opacity of the resulting glass-ceramic article.

The glass-ceramic articles described herein include a crystalline phase and a residual glass phase. In embodiments, the crystalline phase may comprise lithium disilicate. Lithium disilicate, Li₂Si₂O₅, is an orthorhombic crystal based on corrugated sheets of {Si₂O₅} tetrahedral arrays. The crystals are typically tabular or lath-like in shape, with pronounced cleavage planes. Glass-ceramic articles based on lithium disilicate offer highly desirable mechanical properties, including high body strength and fracture toughness, due to their microstructures of randomly-oriented interlocked crystals—a crystal structure that forces cracks to propagate through the material via tortuous paths around these crystals.

In embodiments, lithium disilicate is present in a greater amount as compared to any other crystalline phases, based on a total weight of the crystalline phases in the glass-ceramic article. In embodiments, the total amount of lithium disilicate in the crystalline phase, based on a total weight of the crystalline phase, may be greater than or equal to 30 wt %, greater than or equal to 40 wt %, greater than or equal to 50 wt %, greater than or equal to or equal to 60 wt %, or even greater than or equal to 70 wt %. In embodiments, the total amount of lithium disilicate in the crystalline phase, based on a total weight of the crystalline phase, may be less than or equal to 99 wt %, less than or equal to 90 wt %, or even less than or equal to 80 wt %. In embodiments, the total amount of lithium disilicate in the crystalline phase, based on a total weight of the crystalline phase, may be greater than or equal to 30 wt % and less than or equal to 99 wt %, greater than or equal to 30 wt % and less than or equal to 90 wt %, greater than or equal to 30 wt % and less than or equal to 80 wt %, greater than or equal to 40 wt % and less than or equal to 99 wt %, greater than or equal to 40 wt % and less than or equal to 90 wt %, greater than or equal to 40 wt % and less than or equal to 80 wt %, greater than or equal to 50 wt % and less than or equal to 99 wt %, greater than or equal to 50 wt % and less than or equal to 90 wt %, greater than or equal to 50 wt % and less than or equal to 80 wt %, greater than or equal to 60 wt % and less than or equal to 99 wt %, greater than or equal to 60 wt % and less than or equal to 90 wt %, greater than or equal to 60 wt % and less than or equal to 80 wt %, greater than or equal to 70 wt % and less than or equal to 99 wt %, greater than or equal to 70 wt % and less than or equal to 90 wt %, or even greater than or equal to 70 wt % and less than or equal to 80 wt %, or any and all sub-ranges formed from any of these endpoints.

In embodiments, in addition to lithium disilicate, the crystalline phase of the glass-ceramic article may further comprise lithium metasilicate, lithium phosphate, petalite, β-quartz, apatite, or combinations thereof.

In embodiments, the precursor glass articles described herein may be subjected to certain heat treatments to achieve a glass-ceramic article having relatively small lithium disilicate grains, which may result in a transparent or transparent haze glass-ceramic article. In embodiments, the grains of lithium disilicate of the crystalline phase may comprise a grain size greater than or equal to 10 nm, greater than or equal to 25 nm, or even greater than or equal to 50 nm. In embodiments, the grains of lithium disilicate of the crystalline phase may comprise a grain size less than or equal to 200 nm, less than or equal to 150 nm, or even less than or equal to 100 nm. In embodiments, the grains of lithium disilicate of the crystalline phase may comprise a grain size greater than or equal to 10 nm and less than or equal to 200 nm, greater than or equal to 10 nm and less than or equal to 150 nm, greater than or equal to 10 nm and less than or equal to 100 nm, greater than or equal to 25 nm and less than or equal to 200 nm, greater than or equal to 25 nm and less than or equal to 150 nm, greater than or equal to 25 nm and less than or equal to 100 nm, greater than or equal to 50 nm and less than or equal to 200 nm, greater than or equal to 50 nm and less than or equal to 150 nm, or even greater than or equal to 50 nm and less than or equal to 100 nm, or any and all sub-ranges formed from any of these endpoints.

In embodiments, the grains of lithium disilicate of the crystalline phase may comprise an aspect ratio greater than or equal to 2:1, greater than or equal to 5:1, greater than or equal to 10:1, greater than or equal to 20:1, or even greater than or equal to 25:1.

In embodiments, the glass-ceramic articles may include greater than or equal to 50 wt % of the crystalline phase by weight of the glass-ceramic article (i.e., wt %) and less than or equal to 50 wt % of the residual glass phase, greater than or equal to 60 wt % of the crystalline phase and less than or equal to 40 wt % of the residual glass phase, greater than or equal to 70 wt % of the crystalline phase and less than or equal to 30 wt % of the residual glass phase, greater than or equal to 80 wt % of the crystalline phase and less than or equal to 20 wt % of the residual glass phase, or even greater than or equal to 90 wt % of the crystalline phase and less than or equal to 10 wt %, or any and all sub-ranges formed from any of these endpoints as determined according to Rietveld analysis of the XRD spectrum.

The glass-ceramic article may be provided as a sheet, which may then be reformed by pressing, blowing, bending, sagging, vacuum forming, or other means into curved or bent pieces of uniform thickness.

The glass-ceramic articles described herein may be used for a variety of applications including, for example, for cover glass or glass backplane applications in consumer or commercial electronic devices including, for example, LCD and LED displays, computer monitors, and automated teller machines (ATMs); for touch screen or touch sensor applications, for portable electronic devices including, for example, mobile telephones, personal media players, watches and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (e.g., smartphones, tablet computers, watches, personal computers, ultrabooks, televisions, and cameras), an architectural glass, and/or an automotive glass may comprise a glass-article article as described herein.

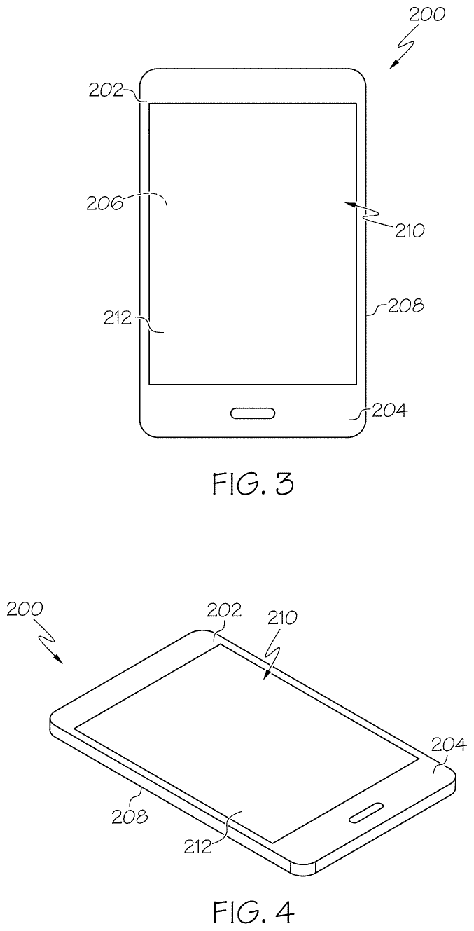

An exemplary electronic device incorporating any of the glass-ceramic articles disclosed herein is shown in FIGS. 3 and 4. Specifically, FIGS. 3 and 4 show a consumer electronic device 200 including a housing 202 having front 204, back 206, and side surfaces 108; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In embodiments, at least a portion of at least one of the cover substrate 212 and the housing 202 may include any of the glass-ceramic articles disclosed herein.

### EXAMPLES

In order that various embodiments be more readily understood, reference is made to the following examples, which are intended to illustrate various embodiments of the precursor glass compositions and glass-ceramic articles described herein.

Table 1 shows example glass compositions and a comparative precursor glass composition (in terms of mol %) and the liquidus temperatures of the precursor glass compositions.

TABLE 1

| Example | 1 | 2 | 3 | 4 | 5 | 6 |
|---|---|---|---|---|---|---|
| SiO₂ | 60.0 | 60.9 | 60.3 | 59.7 | 59.1 | 58.5 |
| Al₂O₃ | 2.0 | 1.5 | 1.5 | 1.5 | 1.5 | 1.4 |
| Li₂O | 26.0 | 24.4 | 25.1 | 25.9 | 26.6 | 27.3 |
| Na₂O | 1.0 | 1.0 | 1.0 | 1.0 | 1.0 | 1.0 |
| K₂O | — | — | — | — | — | — |
| CaO | 5.5 | 6.6 | 6.5 | 6.4 | 6.4 | 6.3 |
| MgO | — | — | — | — | — | — |
| ZrO₂ | 3.4 | 3.5 | 3.5 | 3.4 | 3.4 | 3.4 |
| P₂O₅ | 2.2 | 2.1 | 2.2 | 2.1 | 2.1 | 2.1 |
| F- | — | — | — | — | — | — |
| Al₂O₃/SiO₂ | 0.03 | 0.02 | 0.02 | 0.03 | 0.03 | 0.02 |
| Li₂O/SiO₂ | 0.43 | 0.40 | 0.42 | 0.43 | 0.45 | 0.47 |
| R₂O | 27.0 | 25.4 | 26.1 | 26.9 | 27.6 | 28.3 |
| R′O | 5.5 | 6.6 | 6.5 | 6.4 | 6.4 | 6.3 |
| R′O/SiO₂ | 0.09 | 0.11 | 0.11 | 0.11 | 0.11 | 0.11 |
| Liquidus temp. | 1080 | 1100 | 1075 | 1075 | — | — |
| (° C.) | | | | | | |
| Example | 7 | 8 | 9 | 10 | 11 | 12 |
| SiO₂ | 60.6 | 60.6 | 60.3 | 60.9 | 60.6 | 60.3 |
| Al₂O₃ | 2.0 | 1.5 | 1.5 | 1.5 | 1.5 | 1.5 |
| Li₂O | 26.3 | 26.3 | 26.2 | 26.4 | 26.3 | 26.2 |
| Na₂O | 1.0 | 1.0 | 1.0 | 1.0 | 1.5 | 2.0 |
| K₂O | — | — | — | — | — | — |
| CaO | 5.6 | 5.6 | 5.5 | 5.6 | 5.6 | 5.5 |
| MgO | — | — | — | — | — | — |
| ZrO₂ | 2.5 | 3.0 | 3.5 | 2.5 | 2.5 | 2.5 |
| P₂O₅ | 2.0 | 2.0 | 2.0 | 2.0 | 2.0 | 2.0 |
| F- | — | — | — | — | — | — |
| Al₂O₃/SiO₂ | 0.03 | 0.02 | 0.02 | 0.02 | 0.02 | 0.02 |
| Li₂O/SiO₂ | 0.43 | 0.43 | 0.43 | 0.43 | 0.43 | 0.43 |
| R₂O | 27.3 | 27.3 | 27.2 | 27.4 | 27.8 | 28.2 |
| R′O | 5.6 | 5.6 | 5.5 | 5.6 | 5.6 | 5.5 |
| R′O/SiO₂ | 0.09 | 0.09 | 0.09 | 0.09 | 0.09 | 0.09 |
| Liquidus temp. | 985 | 980 | 1075 | 980 | — | — |
| (° C.) | | | | | | |
| Example | 13 | 14 | 15 | 16 | 17 | 18 |
| SiO₂ | 59.8 | 60.3 | 59.8 | 60.6 | 60.0 | 59.5 |
| Al₂O₃ | 1.5 | 2.0 | 2.9 | 2.0 | 2.0 | 1.9 |
| Li₂O | 25.9 | 26.2 | 25.9 | 26.3 | 26.0 | 25.8 |
| Na₂O | 2.9 | 1.5 | 1.5 | 1.0 | 2.0 | 2.9 |
| K₂O | — | — | — | — | — | — |
| CaO | 5.5 | 5.5 | 5.5 | 5.6 | 5.5 | 5.5 |
| MgO | — | — | — | — | — | — |
| ZrO₂ | 2.4 | 2.5 | 2.4 | 2.5 | 2.5 | 2.4 |
| P₂O₅ | 2.0 | 2.0 | 2.0 | 2.0 | 2.0 | 2.0 |
| F- | — | — | — | — | — | — |
| Al₂O₃/SiO₂ | 0.03 | 0.03 | 0.05 | 0.03 | 0.03 | 0.03 |
| Li₂O/SiO₂ | 0.43 | 0.43 | 0.43 | 0.43 | 0.43 | 0.43 |
| R₂O | 28.8 | 27.7 | 27.4 | 27.3 | 28.0 | 28.7 |
| R′O | 5.5 | 5.5 | 5.5 | 5.6 | 5.5 | 5.5 |
| R′O/SiO₂ | 0.09 | 0.09 | 0.09 | 0.09 | 0.09 | 0.09 |
| Liquidus temp. | — | — | — | 975 | 985 | 965 |
| (° C.) | | | | | | |
| Example | 19 | 20 | 21 | 22 | 23 | 24 |
| SiO₂ | 60.0 | 60.3 | 60.6 | 60.9 | 61.1 | 60.9 |
| Al₂O₃ | 1.5 | 1.5 | 1.5 | 1.5 | 1.5 | 1.5 |
| Li₂O | 26.0 | 26.1 | 26.3 | 26.4 | 24.5 | 24.4 |
| Na₂O | 1.0 | 1.0 | 1.0 | 1.0 | 2.0 | 2.0 |
| K₂O | — | — | — | — | — | — |
| CaO | 5.5 | 5.5 | 5.6 | 5.6 | 6.6 | 6.6 |
| MgO | — | — | — | — | — | — |
| ZrO₂ | 3.9 | 3.5 | 3.0 | 2.5 | 1.0 | 1.0 |
| P₂O₅ | 2.2 | 2.2 | 2.2 | 2.2 | 1.7 | 2.0 |
| F- | — | — | — | — | 1.60 | 1.60 |
| Al₂O₃/SiO₂ | 0.03 | 0.02 | 0.02 | 0.02 | 0.02 | 0.02 |
| Li₂O/SiO₂ | 0.43 | 0.43 | 0.43 | 0.43 | 0.40 | 0.40 |
| R₂O | 27.0 | 27.1 | 27.3 | 27.4 | 26.5 | 26.4 |
| R′O | 5.5 | 5.5 | 5.6 | 5.6 | 6.6 | 6.6 |
| R′O/SiO₂ | 0.09 | 0.09 | 0.09 | 0.09 | 0.11 | 0.11 |
| Liquidus temp. | 1100 | 1040 | 985 | 1160 | — | — |
| (° C.) | | | | | | |
| Example | 25 | 26 | 27 | 28 | 29 | 30 |
| SiO₂ | 60.7 | 61.9 | 60.6 | 60.3 | 60.9 | 60.9 |
| Al₂O₃ | 1.5 | 1.5 | 2.0 | 2.5 | 1.5 | 1.5 |
| Li₂O | 24.4 | 24.8 | 24.3 | 24.2 | 24.4 | 24.4 |
| Na₂O | 2.0 | 2.0 | 2.0 | 2.0 | 1.0 | 1.0 |
| K₂O | — | — | — | — | — | — |
| CaO | 6.6 | 6.7 | 6.5 | 6.5 | 6.6 | 6.6 |
| MgO | — | — | — | — | — | — |
| ZrO₂ | 1.0 | 1.0 | 1.0 | 1.0 | 3.5 | 3.5 |
| P₂O₅ | 2.3 | 2.0 | 2.0 | 2.0 | 2.2 | 2.1 |
| F- | 1.60 | — | 1.60 | 1.60 | — | — |
| Al₂O₃/SiO₂ | 0.02 | 0.02 | 0.03 | 0.04 | 0.02 | 0.02 |
| Li₂O/SiO₂ | 0.40 | 0.40 | 0.40 | 0.40 | 0.40 | 0.40 |
| R₂O | 26.4 | 26.8 | 26.3 | 26.2 | 25.4 | 25.4 |
| R′O | 6.6 | 6.7 | 6.5 | 6.5 | 6.6 | 6.6 |
| R′O/SiO₂ | 0.11 | 0.11 | 0.11 | 0.11 | 0.11 | 0.11 |
| Liquidus temp. | — | — | — | — | — | — |
| (° C.) | | | | | | |
| Example | 31 | 32 | 33 | 34 | 35 | 36 |
| SiO₂ | 60.3 | 59.7 | 59.3 | 59.0 | 58.5 | 57.4 |
| Al₂O₃ | 1.5 | 1.5 | 1.5 | 1.4 | 1.4 | 1.4 |
| Li₂O | 25.1 | 25.9 | 23.8 | 23.6 | 23.4 | 23.0 |
| Na₂O | 1.0 | 1.0 | 1.9 | 1.9 | 1.9 | 1.9 |
| K₂O | — | — | — | — | — | — |
| CaO | 6.5 | 6.4 | 6.4 | 6.4 | 7.7 | 9.4 |
| MgO | — | — | — | — | — | — |
| ZrO₂ | 3.5 | 3.4 | 3.4 | 3.9 | 3.3 | 3.3 |
| P₂O₅ | 2.2 | 2.1 | 2.2 | 2.2 | 2.2 | 2.2 |
| F- | — | — | 1.60 | 1.50 | 1.50 | 1.50 |
| Al₂O₃/SiO₂ | 0.02 | 0.03 | 0.03 | 0.02 | 0.02 | 0.02 |
| Li₂O/SiO₂ | 0.42 | 0.43 | 0.40 | 0.40 | 0.40 | 0.40 |
| R₂O | 26.1 | 26.9 | 25.7 | 25.5 | 25.3 | 24.9 |
| R′O | 6.5 | 6.4 | 6.4 | 6.4 | 7.7 | 9.4 |
| R′O/SiO₂ | 0.11 | 0.11 | 0.11 | 0.11 | 0.13 | 0.16 |
| Liquidus temp. | — | — | — | — | — | — |
| (° C.) | | | | | | |
| Example | 37 | 38 | 39 | 40 | 41 | 42 |
| SiO₂ | 59.7 | 59.3 | 58.2 | 62.0 | 59.8 | 59.8 |
| Al₂O₃ | 0.7 | 1.9 | 1.9 | 1.9 | 2.0 | 2.4 |
| Li₂O | 23.9 | 23.8 | 23.3 | 23.0 | 24.0 | 24.0 |
| Na₂O | 2.0 | 1.9 | 1.9 | 1.9 | 2.0 | 2.0 |
| K₂O | — | — | — | — | — | — |
| CaO | 6.4 | 6.4 | 9.5 | 6.2 | 6.5 | 6.5 |
| MgO | — | — | — | — | — | — |
| ZrO₂ | 3.4 | 2.9 | 1.4 | 1.4 | 2.0 | 1.5 |
| P₂O₅ | 2.2 | 2.2 | 2.2 | 2.2 | 2.3 | 2.3 |
| F- | 1.60 | 1.60 | 1.50 | 1.50 | 1.60 | 1.60 |
| Al₂O₃/SiO₂ | 0.01 | 0.03 | 0.03 | 0.03 | 0.03 | 0.04 |
| Li₂O/SiO₂ | 0.40 | 0.40 | 0.40 | 0.37 | 0.40 | 0.40 |
| R₂O | 25.9 | 25.7 | 25.2 | 24.9 | 26.0 | 26.0 |
| R′O | 6.4 | 6.4 | 9.5 | 6.2 | 6.5 | 6.5 |
| R′O/SiO₂ | 0.11 | 0.11 | 0.16 | 0.10 | 0.11 | 0.11 |
| Liquidus temp. | — | — | — | — | — | — |
| (° C.) | | | | | | |
| Example | 43 | 44 | 45 | 46 | 47 | 48 |
| SiO₂ | 59.6 | 59.0 | 59.7 | 62.7 | 64.0 | 59.0 |
| Al₂O₃ | 2.9 | 3.9 | 2.4 | 1.5 | 1.6 | 1.4 |
| Li₂O | 23.9 | 23.6 | 23.9 | 25.2 | 25.8 | 23.7 |
| Na₂O | 1.9 | 1.9 | 2.0 | 2.1 | 2.1 | 1.9 |
| K₂O | — | — | — | — | — | — |
| CaO | 6.4 | 6.4 | 6.5 | 4.1 | 2.1 | 6.3 |
| MgO | — | — | — | — | — | 3.2 |
| ZrO₂ | 1.5 | 1.4 | 1.5 | 1.0 | 1.0 | 1.0 |
| P₂O₅ | 2.2 | 2.2 | 2.4 | 1.7 | 1.8 | 1.9 |
| F- | 1.60 | 1.50 | 1.60 | 1.60 | 1.70 | 1.50 |
| Al₂O₃/SiO₂ | 0.05 | 0.07 | 0.04 | 0.02 | 0.03 | 0.02 |
| Li₂O/SiO₂ | 0.40 | 0.40 | 0.40 | 0.40 | 0.40 | 0.40 |
| R₂O | 25.8 | 25.5 | 25.9 | 27.3 | 27.9 | 25.6 |
| R′O | 6.4 | 6.4 | 6.5 | 4.1 | 2.1 | 9.5 |
| R′O/SiO₂ | 0.11 | 0.11 | 0.11 | 0.07 | 0.03 | 0.16 |
| Liquidus temp. | — | — | — | — | — | — |
| (° C.) | | | | | | |

| Example | Comparative 1 |
|---|---|
| SiO₂ | 71.0 |
| Al₂O₃ | 4.3 |
| Li₂O | 21.8 |
| Na₂O | 0.1 |
| K₂O | — |
| CaO | — |
| MgO | — |
| ZrO₂ | 2 |
| P₂O₅ | 0.8 |
| F- | 0 |
| Al₂O₃/SiO₂ | 0.06 |
| Li₂O/SiO₂ | 0.31 |
| R₂O | 21.9 |
| R′O | 0 |
| R′O/SiO₂ | 0 |
| Liquidus temp. | — |
| (° C.) | |

### Example A—Heat Treatments

Table 2 shows the heat treatment schedule for achieving example glass-ceramic articles, and the respective properties of the glass-ceramic articles. Example glass-ceramic articles E1-E50 having a thickness of 0.8 mm were formed from the example precursor glass compositions 1-48 listed in Table 1.

TABLE 2

| Example | E1 | E2 | E3 | E4 | E5 |
|---|---|---|---|---|---|
| Precursor glass | 1 | 2 | 3 | 4 | 5 |
| composition | | | | | |
| Nucleation hold | 540° C. for 4 hr | 560° C. for 4 hr | 560° C. for 4 hr | 560° C. for 4 hr | 560° C. for 4 hr |
| Crystallization | 690° C. for 1 hr | 690° C. for 1 hr | 690° C. for 1 hr | 690° C. for 1 hr | 680° C. for 1 hr |
| hold | | | | | |
| Appearance | Transparent | Transparent | Transparent | Transparent | Transparent |
| | | haze | haze | | |
| Phase assemblage | Lithium | Lithium | Lithium | Lithium | Lithium |
| | disilicate, | disilicate, | disilicate, | disilicate, | disilicate, |
| | Lithium | Lithium | Lithium | Lithium | Lithium |
| | phosphate | phosphate | phosphate | phosphate | phosphate |
| Elastic modulus | — | — | 108.7 | 110.2 | — |
| (Gpa) | | | | | |
| Shear modulus | — | — | 44.4 | 44.9 | — |
| (Gpa) | | | | | |
| Poisson’s Ratio | — | — | 0.22 | 0.23 | — |
| K_{Ic} (CN) | — | — | 1.21 | 1.13 | — |
| (MPa · m^{1/2}) | | | | | |
| Example | E6 | E7 | E8 | E9 | E10 |
| Precursor glass | 6 | 7 | 8 | 9 | 10 |
| composition | | | | | |
| Nucleation hold | 560° C. for 4 hr | 560° C. for 4 hr | 560° C. for 4 hr | 560° C. for 4 hr | 560° C. for 4 hr |
| Crystallization | 680° C. for 1 hr | 690° C. for 1 hr | 690° C. for 1 hr | 690° C. for 1 hr | 690° C. for 1 hr |
| hold | | | | | |
| Appearance | Transparent | Transparent | Transparent | Transparent | Transparent |
| Phase assemblage | Lithium | Lithium | Lithium | Lithium | Lithium |
| | disilicate, | disilicate, | disilicate, | disilicate, | disilicate, |
| | Lithium | Lithium | Lithium | Lithium | Lithium |
| | phosphate | phosphate | phosphate | phosphate | phosphate |
| Elastic modulus | — | 110.3 | 111.4 | 110 | 111.2 |
| (Gpa) | | | | | |
| Shear modulus | — | 45 | 45.4 | 45.1 | 45.4 |
| (Gpa) | | | | | |
| Poisson’s Ratio | — | 0.23 | 0.23 | 0.22 | 0.22 |
| K_{Ic} (CN) | — | 1.19 | 1.19 | 1.17 | 1.27 |
| (MPa · m^{1/2}) | | | | | |
| Example | E11 | E12 | E13 | E14 | E15 |
| Precursor glass | 11 | 12 | 13 | 14 | 15 |
| composition | | | | | |
| Nucleation hold | 560° C. for 4 hr | 560° C. for 4 hr | 560° C. for 4 hr | 560° C. for 4 hr | 560° C. for 4 hr |
| Crystallization | 690° C. for 1 hr | 690° C. for 1 hr | 690° C. for 1 hr | 690° C. for 1 hr | 690° C. for 1 hr |
| hold | | | | | |
| Appearance | Transparent | Transparent | Transparent | Transparent | Transparent |
| | | | haze | | |
| Phase assemblage | Lithium | Lithium | Lithium | Lithium | Lithium |
| | disilicate, | disilicate, | disilicate, | disilicate, | disilicate, |
| | Lithium | Lithium | Lithium | Lithium | Lithium |
| | phosphate | phosphate | phosphate | phosphate | metasilicate, |
| | | | | | Petalite, |
| | | | | | Lithium |
| | | | | | phosphate |
| Elastic modulus | 110.7 | 110.5 | — | 109.8 | — |
| (Gpa) | | | | | |
| Shear modulus | 45 | 44.9 | — | 44.7 | — |
| (Gpa) | | | | | |
| Poisson’s Ratio | 0.23 | 0.23 | — | 0.23 | — |
| K_{Ic} (CN) | — | — | — | — | — |
| (MPa · m^{1/2}) | | | | | |
| Example | E16 | E17 | E18 | E19 | E20 |
| Precursor glass | 16 | 17 | 18 | 19 | 20 |
| composition | | | | | |
| Nucleation hold | 540° C. for 4 hr | 540° C. for 4 hr | 540° C. for 4 hr | 540° C. for 4 hr | 540° C. for 4 hr |
| Crystallization | 690° C. for 1 hr | 690° C. for 1 hr | 690° C. for 1 hr | 690° C. for 1 hr | 690° C. for 1 hr |
| hold | | | | | |
| Appearance | Transparent | Transparent | Transparent | Transparent | Transparent |
| | | | | haze | |
| Phase assemblage | Lithium | Lithium | Lithium | Lithium | Lithium |
| | disilicate, | disilicate, | disilicate, | disilicate, | disilicate, |
| | Lithium | Lithium | Lithium | Lithium | Lithium |
| | phosphate | phosphate | phosphate | metasilicate, | metasilicate, |
| | | | | Lithium | Lithium |
| | | | | phosphate | phosphate |
| Elastic modulus | — | — | — | — | — |
| (Gpa) | | | | | |
| Shear modulus | — | — | — | — | — |
| (Gpa) | | | | | |
| Poisson’s Ratio | — | — | — | — | — |
| K_{Ic} (CN) | — | — | — | — | — |
| (MPa · m^{1/2}) | | | | | |
| Example | E21 | E22 | E23 | E24 | E25 |
| Precursor glass | 21 | 22 | 23 | 24 | 25 |
| composition | | | | | |
| Nucleation hold | 540° C. for 4 hr | 540° C. for 4 hr | 525° C. for 4 hr | 525° C. for 4 hr | 525° C. for 4 hr |
| Crystallization | 690° C. for 1 hr | 690° C. for 1 hr | 635° C. for 4 hr | 635° C. for 4 hr | 635° C. for 4 hr |
| hold | | | | | |
| Appearance | Transparent | Transparent | Transparent | Transparent | Transparent |
| | | | haze | haze | |
| Phase assemblage | Lithium | Lithium | Lithium | Lithium | Lithium |
| | disilicate, | disilicate, | disilicate, | disilicate, | disilicate, |
| | Lithium | Lithium | F-apatite | F-apatite | Lithium |
| | metasilicate, | phosphate | | | metasilicate, |
| | Lithium | | | | F-apatite |
| | phosphate | | | | |
| Elastic modulus | — | — | 113 | 112.5 | 111.7 |
| (Gpa) | | | | | |
| Shear modulus | — | — | 46.3 | 46 | 45.7 |
| (Gpa) | | | | | |
| Poisson’s Ratio | — | — | 0.22 | 0.22 | 0.22 |
| K_{Ic} (CN) | — | — | — | — | 1.35 |
| (MPa · m^{1/2}) | | | | | |
| Example | E26 | E27 | E28 | E29 | E30 |
| Precursor glass | 26 | 27 | 28 | 29 | 30 |
| composition | | | | | |
| Nucleation hold | 525° C. for 4 hr | 525° C. for 4 hr | 525° C. for 4 hr | 560° C. for 4 hr | 560° C. for 4 hr |
| Crystallization | 635° C. for 4 hr | 635° C. for 4 hr | 635° C. for 4 hr | 690° C. for 1 hr | 690° C. for 1 hr |
| hold | | | | | |
| Appearance | Transparent | Transparent | Transparent | Transparent | Transparent |
| | haze | haze | haze | haze | haze |
| Phase assemblage | Lithium | Lithium | Lithium | Lithium | Lithium |
| | disilicate, | disilicate, | disilicate, | disilicate, | disilicate, |
| | Lithium | Lithium | Lithium | Lithium | Lithium |
| | metasilicate, | metasilicate, | metasilicate, | phosphate | phosphate |
| | Lithium | F-apatite, | F-apatite, | | |
| | phosphate | Lithium | Lithium | | |
| | | phosphate | phosphate | | |
| Elastic modulus | — | — | — | — | — |
| (Gpa) | | | | | |
| Shear modulus | — | — | — | — | — |
| (Gpa) | | | | | |
| Poisson’s Ratio | — | — | — | — | — |
| K_{Ic} (CN) | — | — | — | — | — |
| (MPa · m^{1/2}) | | | | | |
| Example | E31 | E32 | E33 | E34 | E35 |
| Precursor glass | 31 | 32 | 33 | 34 | 35 |
| composition | | | | | |
| Nucleation hold | 560° C. for 4 hr | 560° C. for 4 hr | 545° C. for 4 hr | 545° C. for 4 hr | 545° C. for 4 hr |
| Crystallization | 690° C. for 1 hr | 690° C. for 1 hr | 640° C. for 1 hr | 640° C. for 1 hr | 640° C. for 1 hr |
| hold | | | | | |
| Appearance | Transparent | Transparent | Transparent | Transparent | Transparent |
| | haze | haze | haze | | |
| Phase assemblage | Lithium | Lithium | Lithium | Lithium | Lithium |
| | disilicate, | disilicate, | disilicate, | disilicate, | disilicate, |
| | Lithium | Lithium | F-apatite, | Lithium | F-apatite, |
| | phosphate | phosphate | Lithium | metasilicate, | Lithium |
| | | | phosphate | F-apatite, | phosphate |
| | | | | Lithium | |
| | | | | phosphate | |
| Elastic modulus | 108.7 | 110.2 | — | — | — |
| (Gpa) | | | | | |
| Shear modulus | 44.4 | 44.9 | — | — | — |
| (Gpa) | | | | | |
| Poisson’s Ratio | 0.224 | 0.228 | — | — | — |
| K_{Ic} (CN) | 1.21 | 1.13 | — | — | — |
| (MPa · m^{1/2}) | | | | | |
| Example | E36 | E37 | E38 | E39 | E40 |
| Precursor glass | 36 | 37 | 38 | 39 | 40 |
| composition | | | | | |
| Nucleation hold | 545° C. for 4 hr | 545° C. for 4 hr | 545° C. for 4 hr | 545° C. for 4 hr | 545° C. for 4 hr |
| Crystallization | 640° C. for 1 hr | 640° C. for 1 hr | 680° C. for 1 hr | 680° C. for 1 hr | 680° C. for 1 hr |
| hold | | | | | |
| Appearance | Transparent | Transparent | Transparent | Transparent | Transparent |
| | haze | | haze | haze | haze |
| Phase assemblage | Lithium | Lithium | Lithium | Lithium | Lithium |
| | disilicate, | disilicate, | disilicate, | disilicate, | disilicate, |
| | F-apatite, | F-apatite, | F-apatite, | F-apatite, | F-apatite, |
| | Lithium | Lithium | Lithium | Lithium | Lithium |
| | phosphate | phosphate | phosphate | phosphate | phosphate |
| Elastic modulus | — | — | — | — | — |
| (Gpa) | | | | | |
| Shear modulus | — | — | — | — | — |
| (Gpa) | | | | | |
| Poisson’s Ratio | — | — | — | — | — |
| K_{Ic} (CN) | — | — | — | — | — |
| (MPa · m^{1/2}) | | | | | |
| Example | E41 | E42 | E43 | E44 | E45 |
| Precursor glass | 41 | 42 | 43 | 44 | 45 |
| composition | | | | | |
| Nucleation hold | 525° C. for 4 hr | 525° C. for 4 hr | 525° C. for 4 hr | 525° C. for 4 hr | 525° C. for 4 hr |
| Crystallization | 630° C. for 4 hr | 630° C. for 4 hr | 630° C. for 4 hr | 630° C. for 4 hr | 630° C. for 4 hr |
| hold | | | | | |
| Appearance | Transparent | Transparent | Transparent | Transparent | Transparent |
| | | | haze | haze | |
| Phase assemblage | Lithium | Lithium | Lithium | Lithium | Lithium |
| | disilicate, | disilicate, | disilicate, | disilicate, | disilicate, |
| | Lithium | Lithium | Lithium | Lithium | Lithium |
| | metasilicate, | metasilicate, | metasilicate, | metasilicate, | metasilicate, |
| | F-apatite, | F-apatite, | F-apatite, | F-apatite, | F-apatite, |
| | Lithium | Lithium | Lithium | Lithium | Lithium |
| | phosphate | phosphate | phosphate | phosphate, | phosphate |
| | | | | Petalite | |
| Elastic modulus | — | — | — | — | — |
| (Gpa) | | | | | |
| Shear modulus | — | — | — | — | — |
| (Gpa) | | | | | |
| Poisson’s Ratio | — | — | — | — | — |
| K_{Ic} (CN) | — | — | — | — | — |
| (MPa · m^{1/2}) | | | | | |
| Example | E46 | E47 | E48 | E49 | E50 |
| Precursor glass | 46 | 47 | 48 | 15 | 4 |
| composition | | | | | |
| Nucleation hold | 525° C. for 4 hr | 525° C. for 4 hr | 525° C. for 4 hr | 540° C. for 4 hr | 590° C. for 4 hr |
| Crystallization | 600° C. for 1 hr | 600° C. for 1 hr | 600° C. for 1 hr | 670° C. for 1 hr | 690° C. for 1 hr |
| hold | | | | | |
| Appearance | Transparent | Transparent | Transparent | — | — |
| | | haze | haze | | |
| Phase assemblage | Lithium | Lithium | Lithium | Lithium | Lithium |
| | disilicate, | disilicate, | disilicate, | disilicate, | disilicate, |
| | Lithium | Lithium | F-apatite, | Petalite, | Lithium |
| | metasilicate, | metasilicate, | Lithium | Lithium | phosphate |
| | Lithium | Lithium | phosphate | metasilicate, | |
| | phosphate | phosphate | | Lithium | |
| | | | | phosphate | |
| Elastic modulus | — | — | — | — | — |
| (Gpa) | | | | | |
| Shear modulus | — | — | — | — | — |
| (Gpa) | | | | | |
| Poisson’s Ratio | — | — | — | — | — |
| K_{Ic} (CN) | — | — | — | — | — |
| (MPa · m^{1/2}) | | | | | |

As indicated by the example precursor glass compositions in Table 1 and the glass-ceramic articles in Table 2, the precursor glass compositions described herein may be subjected to certain heat treatments to form that are transparent or transparent haze having improved fracture toughness and elastic modulus.

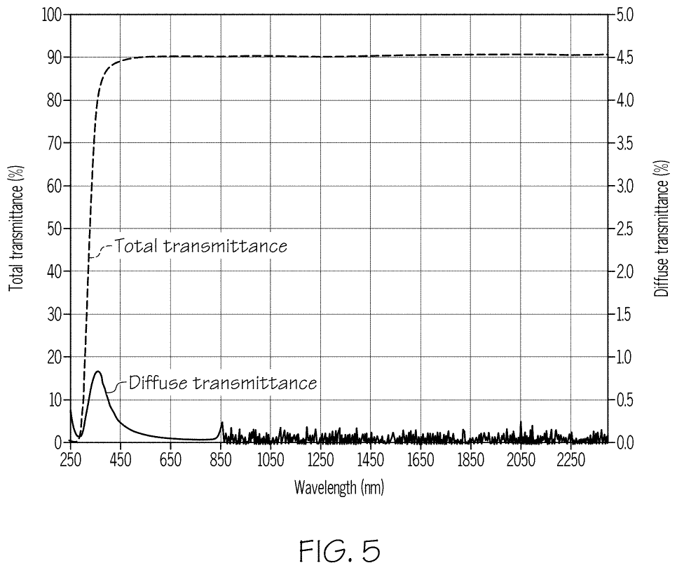

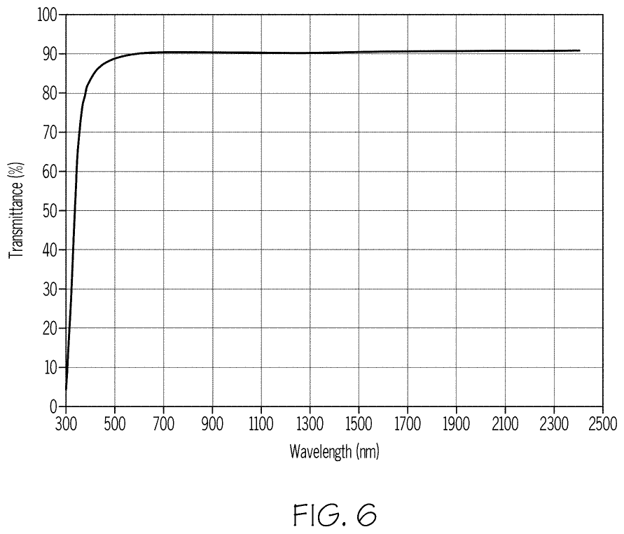

Referring now to FIG. 5, example glass-ceramic article E4 shown in Table 2, formed by subjecting example precursor glass composition 4 to a nucleation hold at 560° C. for 4 hours and a crystallization hold at 690° C. for 1 hour, had an average total transmittance of 90% over the wavelength range of 400 nm to 800 nm, indicating that specified heat treatment of example precursor glass composition 4 resulted in a transparent glass-ceramic article. Referring now to FIG. 6, example glass-ceramic article E31 shown in Table 2, formed by subjecting example precursor glass composition 31 to a nucleation hold at 560° C. for 4 hours and a crystallization hold at 690° C. for 1 hour, had an average total transmittance of 90% over the wavelength range of 400 nm to 800 nm, indicating that specified heat treatment of example precursor glass composition 31 resulted in a transparent haze glass-ceramic article. As indicated by FIGS. 5 and 6, heat treating the precursor glass compositions described herein at relatively lower temperatures (e.g., nucleation hold at 560° C. and crystallization hold at 690° C.) results in transparent or transparent haze glass-ceramic articles.

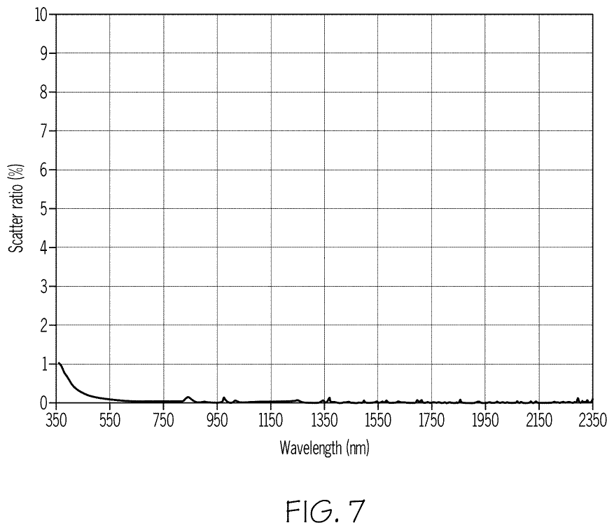

Referring back to FIG. 5, example glass-ceramic article E4 had an average diffuse transmittance of 0.18 over the wavelength range of 400 nm to 800 nm. Referring now to FIG. 7, example glass-ceramic article E4 had an average scatter ratio of 0.13 over the wavelength range of 400 nm to 800 nm. As indicated by FIGS. 5 and 7, the precursor glass compositions described herein may be subjected to certain heat treatments to form glass-ceramic articles having relatively low diffuse transmittance and scatter ratios, which means less scattering of light. While not wishing to be bound by theory, the relatively low diffuse transmittance and scatter ratios may be due to the similarity of the refractive indices of the crystalline phases and/or due to the smaller grain size of the lithium disilicate grains.

Referring now to FIG. 8, example glass-ceramic article E49, formed by subjecting example precursor glass composition 15 to a nucleation hold at 540° C. for 4 hours and a crystallization hold at 670° C. for 1 hour, had lithium disilicate present in the highest amount and also included petalite, lithium metasilicate, and lithium phosphate. As indicated by FIG. 8, the precursor glass compositions described herein may be subjected to certain heat treatments to achieve a glass-ceramic article including lithium disilicate.

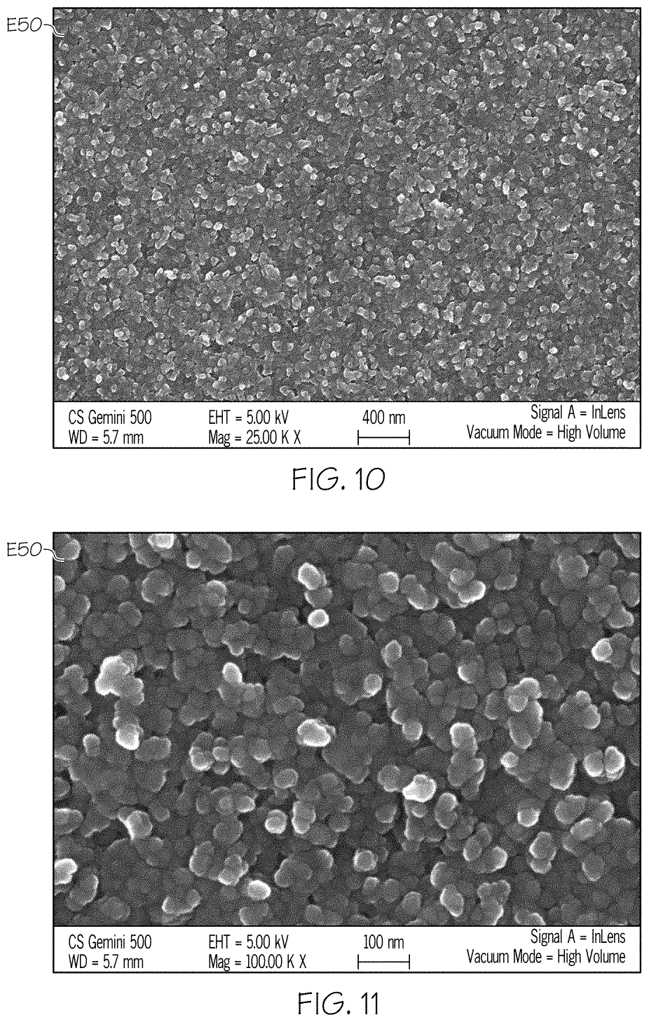

Referring now to FIG. 9, example glass-ceramic article E50, formed by subjecting example precursor glass composition 4 to a nucleation hold at 590° C. for 4 hours and a crystallization hold at 690° C. for 1 hour, had lithium disilicate present in the highest amount and also included lithium phosphate. Referring now to FIGS. 10 and 11, example glass-ceramic article E50 included lithium disilicate grains having a grain sizes in the range of 50 to 100 nm. As indicated by FIGS. 8-11, the precursor glass compositions described herein may be subjected to certain heat treatments to achieve a glass-ceramic article including lithium disilicate and having a relatively small lithium disilicate grain size, which may result in a transparent or transparent haze glass-ceramic article.

### Example B: Nucleation Hold

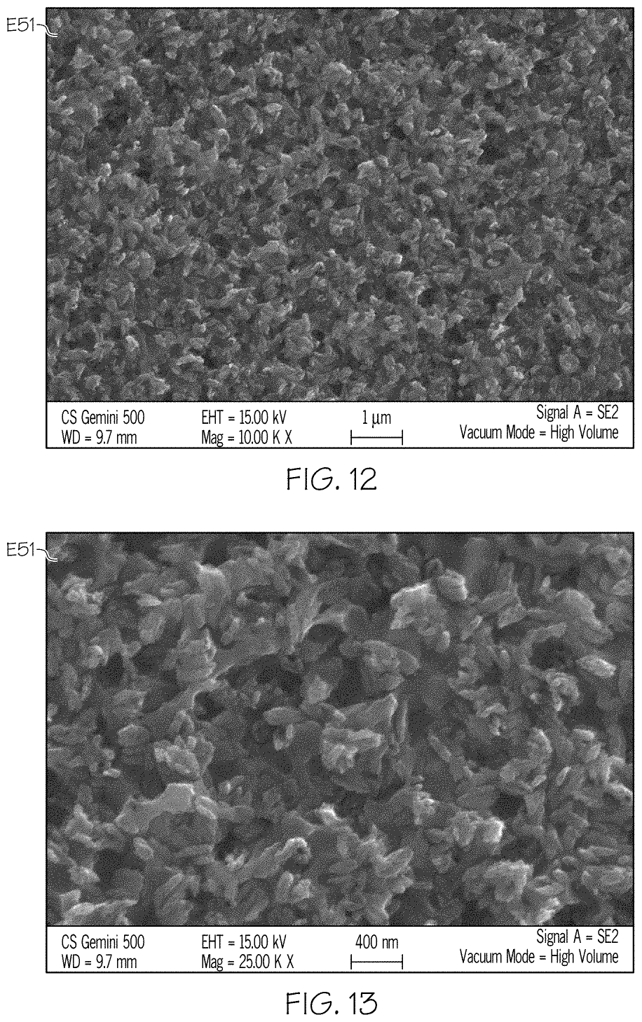

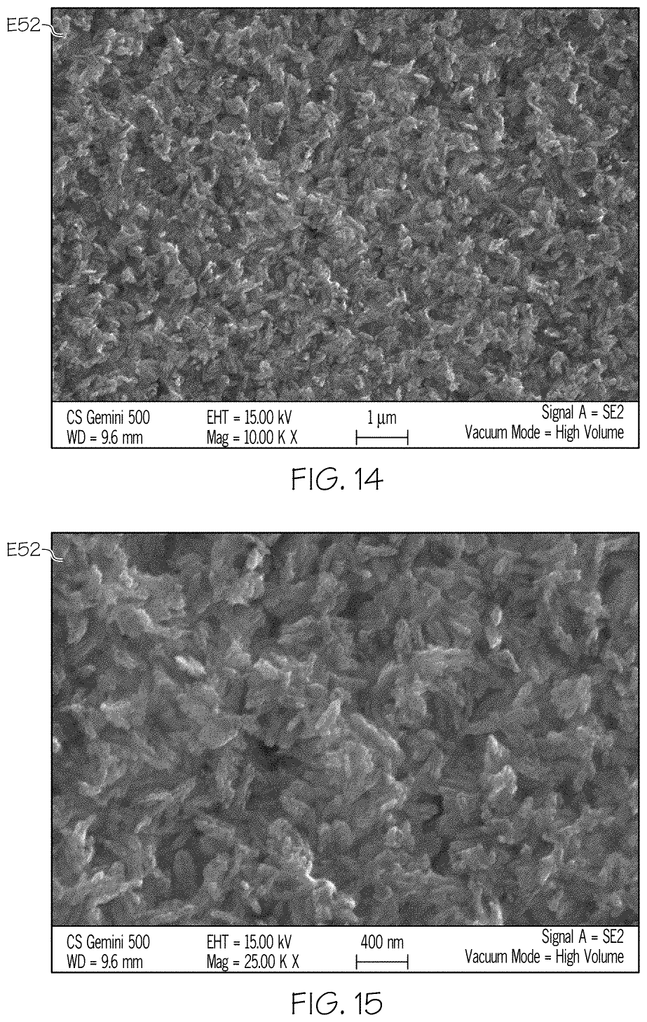

Referring now to FIGS. 12 and 13, example glass-ceramic article E51, formed by subjecting example precursor glass composition 23 to a nucleation hold at 550° C. for 1 hour, had a lithium disilicate grain size in the range of 30 to 50 nm. Referring now to FIGS. 14 and 15, example glass-ceramic article E52 formed by subjecting example precursor glass composition 23 to a nucleation hold at a nucleation hold at 550° C. for 8 hours, had a lithium disilicate grain size in the range of 50 to 200 nm.

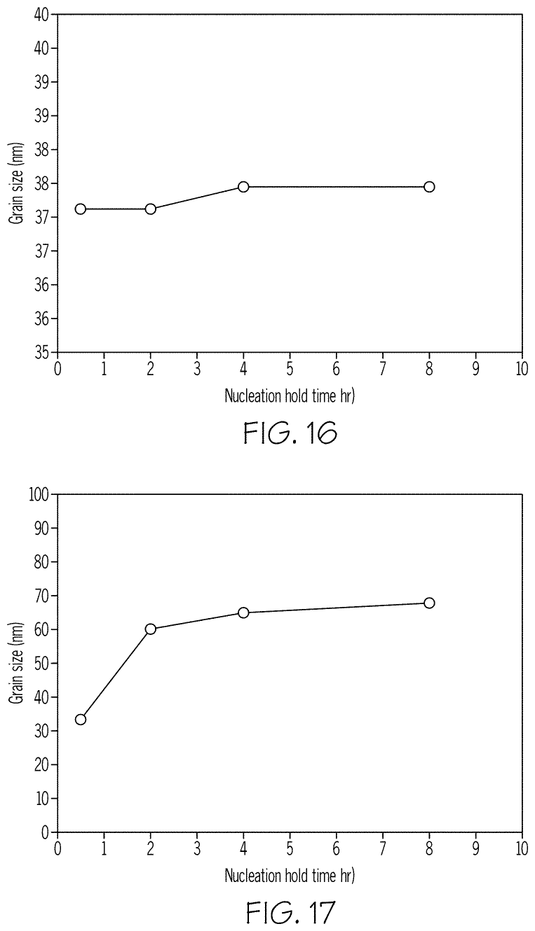

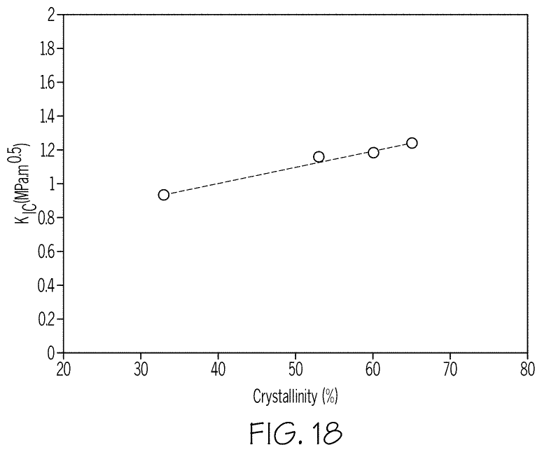

Referring now to FIGS. 16, 17, and 18, glass-ceramic articles were formed by subjecting precursor glass composition 23 to a nucleation hold at 550° C. for 0.5 hours, 2 hours, 4 hours, and 8 hours, respectively. As shown in FIG. 16, the lithium disilicate grain size was not significantly altered by longer nucleation hold times. As shown in FIG. 17, the crystallinity of the glass-ceramic articles significantly increased with the longer nucleation hold times. As shown in FIG. 18, fracture toughness increased with the crystallinity of the glass-ceramic article.

As indicated in FIGS. 12-18, subjecting the precursor glass compositions described herein to a nucleation hold at relatively lower nucleation temperatures increases the crystallinity, and thus, the fracture toughness, of the resulting glass-ceramic articles without increasing the lithium disilicate grain size, which may decrease the transmittance of the glass-ceramic article.

### Example C: Crystallization Hold

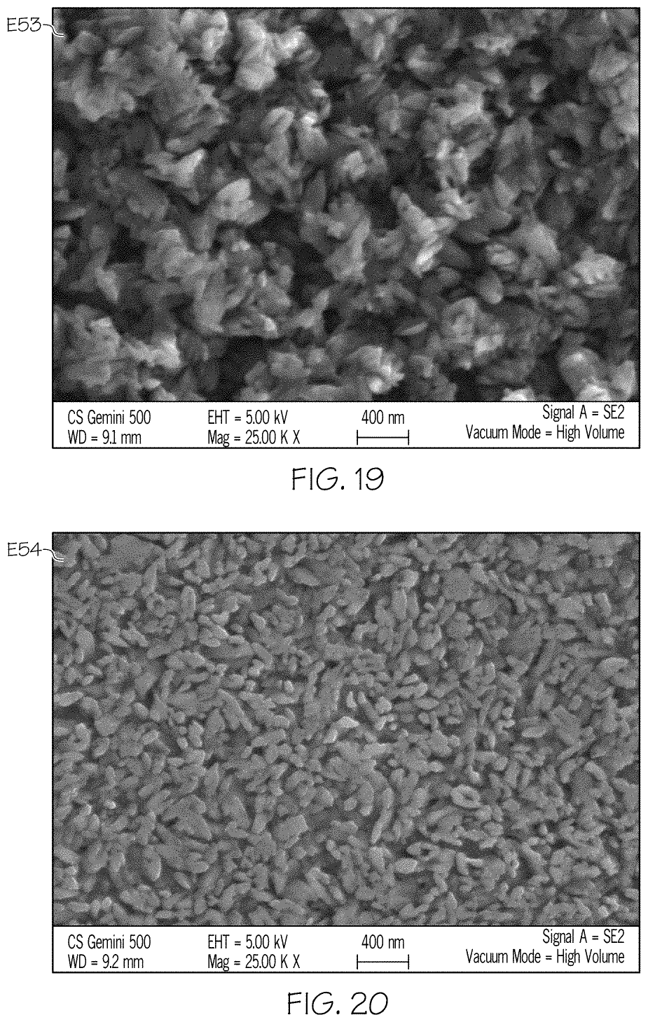

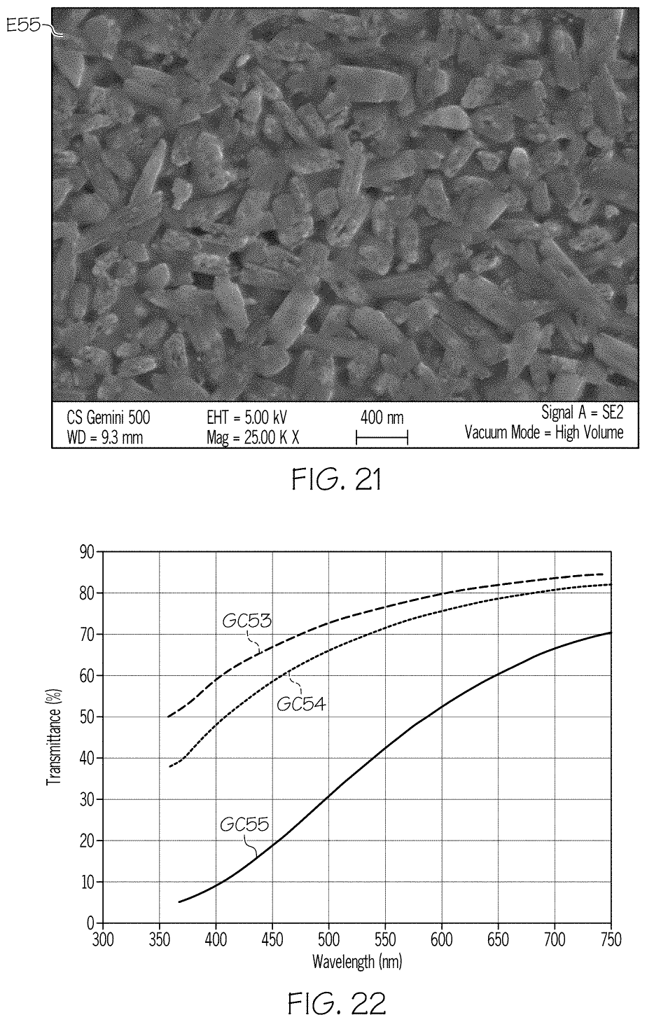

Glass-ceramic articles E53, E54, and E55 were formed by subjecting precursor glass composition 23 to a nucleation hold at 550° C. for 4 hours and a crystallization hold at 600° C., 750° C., and 850° C., respectively, for 5 minutes. Referring now to FIGS. 19-21, an increase in lithium disilicate grain size and an interlocking microstructure were observed with increasing crystallization temperatures. Referring now to FIG. 22, the transmittance of the resulting glass-ceramic articles decrease as the crystallization hold temperature increases.

As indicated by FIGS. 19-22, subjecting the precursor glass compositions described herein to a crystallization hold at relatively lower crystallization temperatures results in glass-ceramic articles with a relatively increased transmittance, which may be attributed to a relatively smaller lithium disilicate grain size.

### Example C: Ion Exchange and Maximum Central Tension

As shown in Table 2, example glass-ceramic article E4 was formed by subjecting example precursor glass composition 4 to a nucleation hold at 560° C. for 4 hours and a crystallization hold at 690° C. for 1 hour. Comparative glass-ceramic article Cl was formed by subjecting comparative precursor glass composition 1 to the same heat treatment used to form example glass-ceramic article E4.

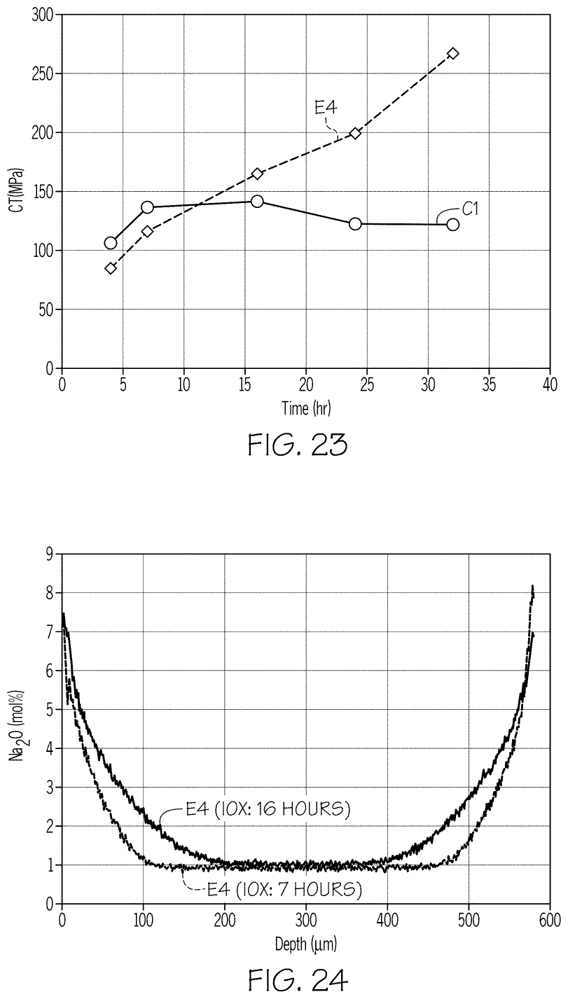

Referring now to FIG. 23, example glass-ceramic article E4 and comparative glass-ceramic article Cl were ion exchanged in a 100% NaNO₃ bath at 470° C. for 4 hours, 7 hours, 16 hours, 24 hours, and 32 hours, respectively. Referring now to FIG. 23, example glass-ceramic article E4 achieved a higher maximum central tension than comparative glass-ceramic article Cl.

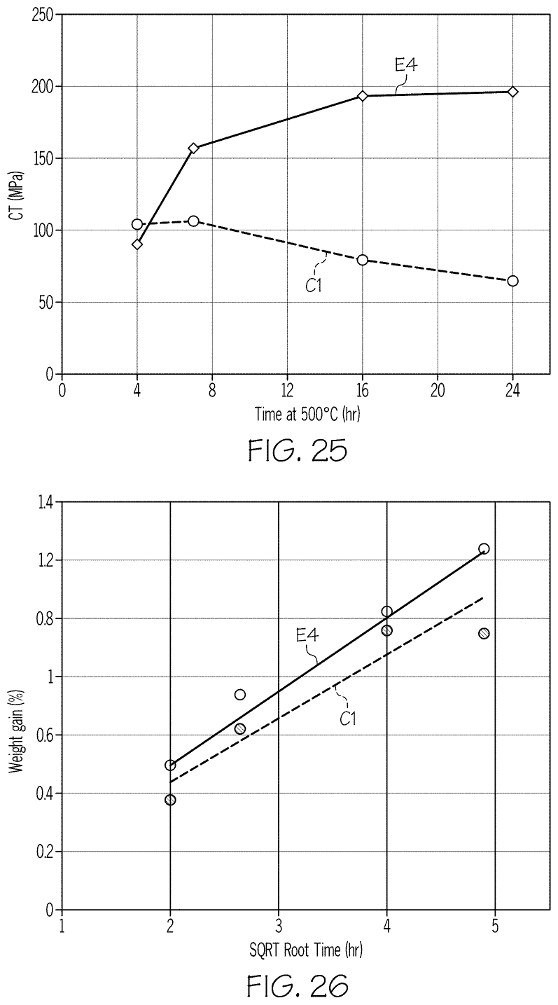

Referring now to FIG. 24, example glass-ceramic article E4 and comparative glass-ceramic article Cl were ion exchanged in a 60% KNO₃/40% NaNO₃+0.12% LiNO₃ molten salt bath for 4 hours, 7 hours, 16 hours, and 24 hours, respectively. Ion exchanging example glass-ceramic article E4 for 16 hours resulted in a near parabolic profile of sodium ions exchanged into the article. Referring now to FIG. 25, example glass-ceramic article E4 achieved a higher maximum central tension than comparative glass-ceramic article Cl. As shown in FIG. 26, example glass-ceramic article E4 had an increase in weight, which indicates that there was more Li₂O in the residual glass phase available for ion exchange. Additional Li₂O in the residual glass phase may lead to a higher central tension.

As indicated by FIGS. 23 and 25, the precursor glass compositions described herein may be subjected to certain ion exchange conditions to achieve a relatively higher maximum central tension. While not wishing to be bound by theory, a relatively higher amount of Li₂O is present in the residual glass phase for ion exchange, as evidenced by the weight gain data shown in FIG. 26, and is believed to result in an increased maximum central tension.

As indicated by FIG. 26, the glass-ceramic articles formed from the precursor glass compositions described herein result in a relatively greater amount of Li ions present in the glass-ceramic article being replaced with the Na ions present in the ion exchange bath, which results in a relatively higher maximum central tension. While not wishing to be bound by theory, the glass-ceramic articles described herein have a relatively high about of Li₂O present in the residual glass phase that may be readily ion exchanged.

### Example D: Ion Exchange and Stored Strain Energy

Table 3 shows the ion exchange conditions for achieving example ion exchanged glass-ceramic articles, and the respective properties of the ion exchanged glass-ceramic articles. Example glass-ceramic articles E56-E64 were formed having the example precursor glass composition 4 listed in Table 1 and subjected to a nucleation hold at 540° C. for 4 hours and a crystallization hold at 670° C. for 1 hour.

TABLE 3

| Example | E56 | E57 | E58 | E59 | E60 |
|---|---|---|---|---|---|
| Salt bath | 60% | 60% | 60% | 60% | 100% |
| composition | KNO₃/40% | KNO₃/40% | KNO₃/40% | KNO₃/40% | NaNO₃ |
| | NaNO₃ + | NaNO₃ + | NaNO₃ + | NaNO₃ + | |
| | 0.12% LiNO₃ | 0.12% LiNO₃ | 0.12% LiNO₃ | 0.12% LiNO₃ | |
| Ion exchange | 500° C. | 500° C. | 500° C. | 500° C. | 470° C. |
| schedule | for 4 hr | for 7 hr | for 16 hr | for 24 hr | for 4 hr |
| Maximum central | 90.4 | 156.9 | 193.4 | 196.6 | 84.7 |
| tension (MPa) | | | | | |
| SSE (J/m²) | 16.55 | 33.67 | 48.89 | 52.77 | 16.04 |

| Example | E61 | E62 | E63 | E64 |
|---|---|---|---|---|
| Salt bath | 100% NaNO₃ | 100% NaNO₃ | 100% NaNO₃ | 100% NaNO₃ |
| composition | | | | |
| Ion exchange | 470° C. | 470° C. | 470° C. | 470° C. |
| schedule | for 7 hr | for 16 hr | for 24 hr | for 32 hr |
| Maximum central | 116.2 | 164.8 | 199.2 | 267 |
| tension (MPa) | | | | |
| SSE (J/m²) | 25.14 | 46.39 | 64.55 | 90.87 |

As indicated by the glass-ceramic articles in Table 3, the glass-ceramic articles formed form the precursor glass compositions described herein may be subjected to certain ion exchange conditions to achieve a high maximum central tension and a high stored strain energy.

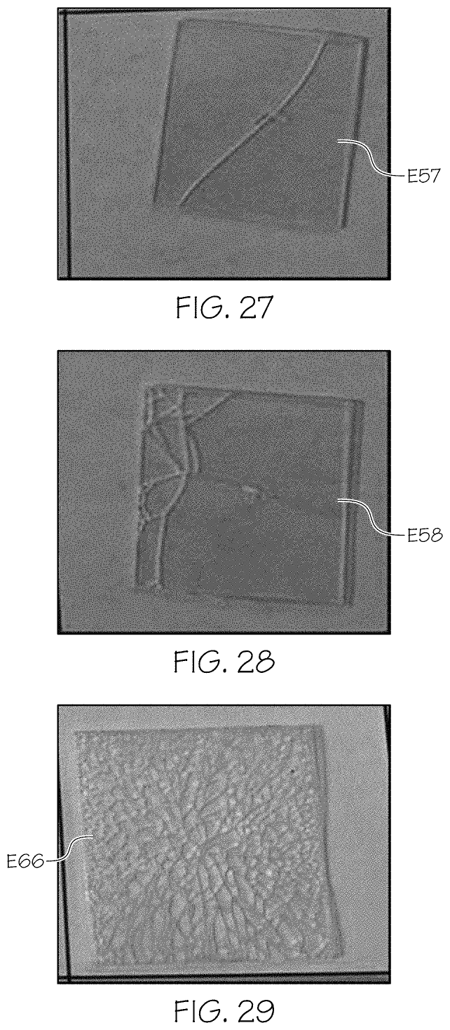

Referring now to FIGS. 27-29, example glass-ceramic articles E57, E58, and E59 were subjected to a frangibility test. As shown in FIGS. 27 and 28, a large amount of cracking (i.e., dicing) was not observed in example glass-ceramic article E57 having a maximum central tension of 156.9 MPa and a stored strain energy of 33.67 J/m² and example glass-ceramic article E58 having a maximum central tension of 193.4 MPa and a stored strain energy of 48.89 J/m². As shown in FIG. 29, a large amount of cracking (i.e., dicing) was observed in example glass-ceramic article E64 having a maximum central tension of 267 MPa and a stored strain energy of 90.87 J/m². As indicated by FIGS. 27-29, the glass-ceramic articles formed from the precursor glass compositions described herein may be subjected to certain ion exchange conductions to achieve relatively high central tension and relatively high stored strain energy, related to high fracture toughness and high elastic modulus, while staying below the frangibility limit. While not wishing to be bound by theory, it is believed that the crystal structure of the lithium disilicate crystalline phase enables the glass-ceramic articles described herein to achieve relatively high central tension, fracture toughness, and elastic modulus without being frangible.

### Example E: Ion Exchange and Aging

Example glass-ceramic articles E65-E68 were formed by subjecting example precursor glass composition 4 to a nucleation hold at 640° C. for 4 hours and a nucleation hold at 770° C. for 4 hours. Example glass-ceramic articles E66 and E68 were subjected to ion exchange in a 60% KNO₃/40% NaNO₃+0.12% LiNO₃ molten salt bath for 24 hours. Example glass-ceramic articles E65 and E67 were not ion exchanged. The example glass-ceramic articles were subjected to accelerated aging tests in a 85° C. and 85% humidity chamber. Example glass-ceramic articles E65 and E66 were aged for 72 hours and example glass-ceramic articles E69 and E70 were aged for 500 hours.

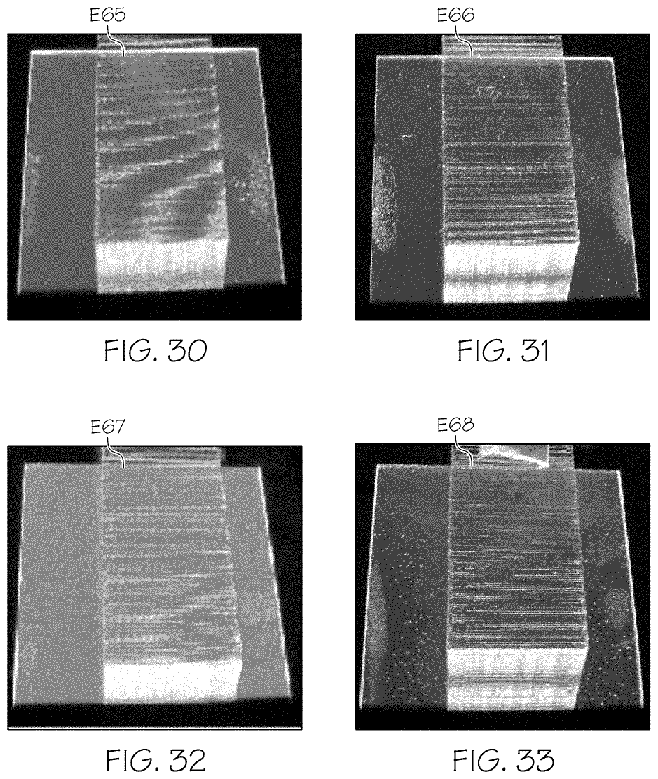

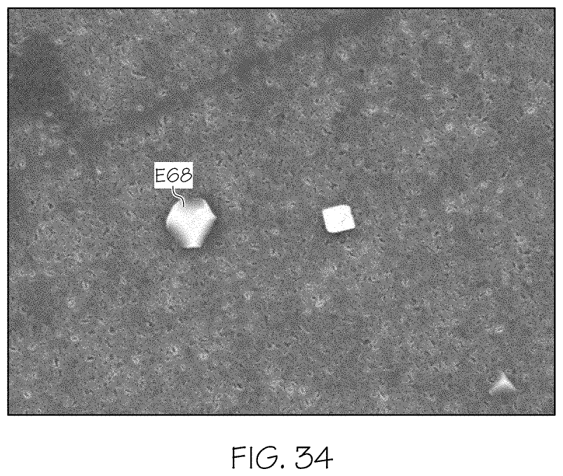

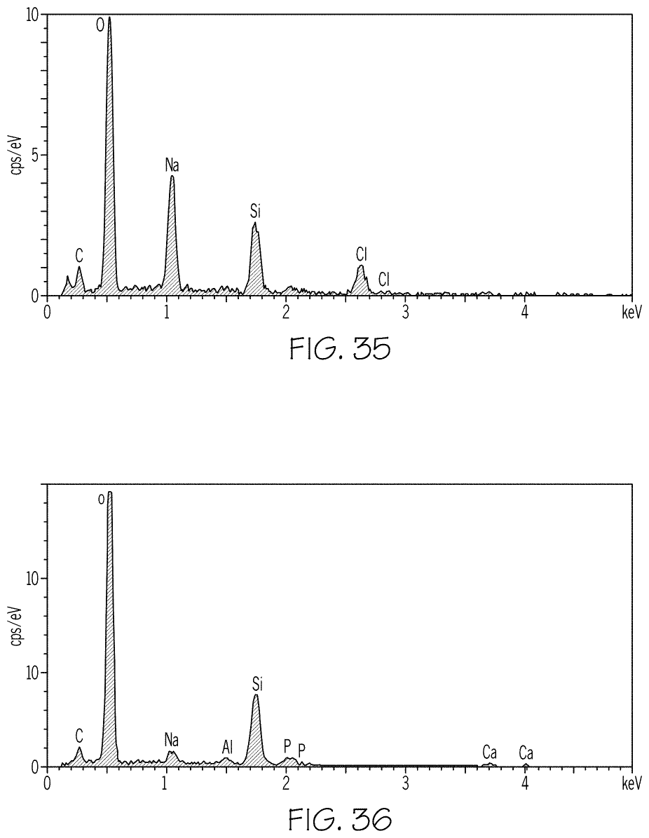

Referring now to FIGS. 30-33, no corrosion was observed for any of the example glass-ceramic articles after aging, including ion exchanged glass-ceramic articles E66 and E68. Referring now to FIGS. 34-36, NaCl was identified as the major phase in the ion exchanged and aged glass-ceramic article E68. While not wishing to be bound by theory, it is believed that NaCl, and not Na₂O, was the major phase due to contamination from impurities in the water. As indicated in FIGS. 30-36, glass-ceramic articles formed from the precursor glass compositions described herein may be ion exchanged and may not undergo corrosion, even with high levels of Na₂O at the surface of the article.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A glass-ceramic article comprising:
a crystalline phase;
a residual glass phase;
greater than or equal to 52 mol % and less than or equal to 70 mol % SiO₂;
greater than or equal to 14 mol % and less than or equal to 35 mol % Li₂O;
greater than or equal to 0.1 mol % and less than or equal to 15 mol % CaO;
greater than or equal to 0.5 mol % and less than or equal to 10 mol % ZrO₂; and
greater than or equal to 0.5 mol % and less than or equal to 5 mol % P₂O₅.

2. The glass-ceramic article of claim 1, wherein the crystalline phase comprises lithium disilicate, wherein lithium disilicate is present in a greater amount, based on a total weight of the crystalline phase, than any other crystalline phase.

3. The glass-ceramic article of claim 2, wherein grains of the lithium disilicate comprise a grain size greater than or equal to 10 nm and less than or equal to 200 nm.

4. The glass-ceramic article of claim 1, wherein the glass-ceramic article comprises greater than or equal to 18 mol % and less than or equal to 32 mol % Li₂O.

5. The glass-ceramic article of claim 1, wherein the glass-ceramic article comprises greater than or equal to 0.5 mol % and less than or equal to 7 mol % ZrO₂.

6. The glass-ceramic article of claim 1, wherein the glass-ceramic article comprises greater than or equal to 1 mol % and less than or equal to 4.5 mol % P₂O₅.

7. The glass-ceramic article of claim 1, wherein a molar ratio of Al₂O₃ to SiO₂ is greater than or equal to 0 and less than or equal to 0.2.

8. The glass-ceramic article of claim 1, wherein a molar ratio of Li₂O to SiO₂ is greater than or equal to 0.2 and less than or equal to 0.7.

9. The glass-ceramic article of claim 1, wherein a molar ratio of RO to SiO₂ is greater than or equal to 0 and less than or equal to 0.3, wherein RO is the sum of CaO, MgO, ZnO, SrO, and BaO.

10. The glass-ceramic article of claim 1, wherein the crystalline phase of the glass-ceramic article comprises lithium metasilicate, lithium phosphate, petalite, β-quartz, apatite, or combinations thereof.

11. The glass-ceramic article of claim 1, wherein an average transmittance of the glass-ceramic article is greater than or equal to 50% and less than or equal to 95% over the wavelength range of 400 nm to 800 nm as measured at an article thickness of 0.8 mm.

12. The glass-ceramic article of claim 1, wherein a K_{lc} fracture toughness of the glass-ceramic article as measured by a double torsion method is greater than or equal to 1.0 MPa·m^{1/2}.

13. The glass-ceramic article of claim 1, wherein an elastic modulus of the glass-ceramic article is greater than or equal to 100 GPa.

14. A glass composition comprising:
greater than or equal to 52 mol % and less than or equal to 70 mol % SiO₂;
greater than or equal to 14 mol % and less than or equal to 35 mol % Li₂O;
greater than or equal to 0.1 mol % and less than or equal to 15 mol % CaO;
greater than or equal to 0.5 mol % and less than or equal to 10 mol % ZrO₂; and
greater than or equal to 0.5 mol % and less than or equal to 5 mol % P₂O₅.

15. The glass composition of claim 14, wherein the glass composition comprises greater than or equal to 18 mol % and less than or equal to 32 mol % Li₂O.

16. The glass composition of claim 14, wherein the glass composition comprises greater than or equal to 0.5 mol % and less than or equal to 7 mol % ZrO₂.

17. The glass composition of claim 14, wherein the glass composition comprises greater than or equal to 1 mol % and less than or equal to 4.5 mol % P₂O₅.

18. A method of forming a glass-ceramic article, the method comprising:
heating a precursor glass article in an oven at a rate greater than or equal to 1° C./min and less than or equal to 10° C./min to a nucleation temperature, wherein the precursor glass article comprises a glass composition comprising:
greater than or equal to 52 mol % and less than or equal to 70 mol % SiO₂;
greater than or equal to 14 mol % and less than or equal to 35 mol % Li₂O;
greater than or equal to 0.1 mol % and less than or equal to 15 mol % CaO;
greater than or equal to 0.5 mol % and less than or equal to 10 mol % ZrO₂; and
greater than or equal to 0.5 mol % and less than or equal to 5 mol % P₂O₅;
maintaining the precursor glass article at the nucleation temperature in the oven for time greater than or equal to 0.1 hour and less than or equal to 8 hours to produce a nucleated crystallizable glass article;
heating the nucleated crystallizable glass article in the oven at a rate greater than or equal to 1° C./min and less than or equal to 10° C./min to a crystallization temperature;
maintaining the nucleated crystallizable glass article at the crystallization temperature in the oven for a time greater than or equal to 0.25 hour and less than or equal to 4 hours to produce the glass-ceramic article, wherein the glass-ceramic article comprises a crystalline phase and a residual glass phase; and
cooling the glass-ceramic article to room temperature.

19. The method of claim 18, wherein the crystalline phase comprises lithium disilicate, wherein lithium disilicate is present in a greater amount, based on a total weight of the crystalline phase, than any other crystalline phase.

20. The method of claim 18, further comprising strengthening the glass-ceramic article in an ion exchange bath at a temperature greater than or equal to 350° C. to less than or equal to 500° C. for a time period greater than or equal to 2 hours to less than or equal to 12 hours to form an ion exchanged glass-ceramic article.
